(19) United States
(12) Patent Application Publication
(10) Pub. No.: US 2023/0182764 A1
(43) Pub. Date: Jun. 15, 2023

(54) VEHICLE DISPLAY CONTROL DEVICE, VEHICLE DISPLAY CONTROL SYSTEM, AND VEHICLE DISPLAY CONTROL METHOD

(71) Applicant: DENSO CORPORATION, Kariya-city (JP)

(72) Inventors: Shuntaro FUKUI, Kariya-city (JP); Toshiharu Shiratsuchi, Kariya-city (JP); Shiori Maneyama, Kariya-city (JP); Tetsuya Enokizaka, Kariya-city (JP); Kaneyasu Koide, Kariya-city (JP); Kazuki Izumi, Kariya-city (JP); Takuya Kume, Kariya-city (JP)

(21) Appl. No.: 18/163,402

(22) Filed: Feb. 2, 2023

Related U.S. Application Data
(63) Continuation of application No. PCT/JP2021/028241, filed on Jul. 30, 2021.

(30) Foreign Application Priority Data
Aug. 7, 2020 (JP) 2020-134989
Feb. 18, 2021 (JP) 2021-024612

(51) Int. Cl. B60W 50/14; G06F 3/14; B60W 60/00

(52) U.S. Cl. CPC B60W 50/14; B60W 60/0053; G06F 3/1423; B60W 2050/146

(57) ABSTRACT

A vehicle switches from a without-monitoring-duty automated driving without a duty of monitoring by a driver to a with-monitoring-duty automated driving with the duty of monitoring by the driver. A display control unit causes a display device to display a surrounding state image that shows a surrounding state of the vehicle. A mode identification unit identifies whether automated driving in a hands-on mode, which requires gripping of a steering wheel of the vehicle, or automated driving in a hands-off mode, which does not require gripping of the steering wheel, is performed when the vehicle is in the with-monitoring-duty automated driving. The display control unit differentiates display of the surrounding state image, when the vehicle switches from the without-monitoring-duty automated driving to the with-monitoring-duty automated driving, depending on whether the mode identification unit identifies the automated driving in the hands-on mode or the automated driving in the hands-off mode.

### CROSS REFERENCE TO RELATED APPLICATION

The present application is a continuation application of International Patent Application No. PCT/JP2021/028241 filed on Jul. 30, 2021, which designated the U.S. and claims the benefit of priority from Japanese Patent Applications No. 2020-134989 filed on Aug. 7, 2020 and No. 2021-024612 filed on Feb. 18, 2021. The entire disclosures of all of the above applications are incorporated herein by reference.

### TECHNICAL FIELD

The present disclosure relates to a vehicle display control device, a vehicle display control system, and a vehicle display control method.

### BACKGROUND

Conventionally, a known vehicle has an automated driving mode. The vehicle is configured to switch from a manual driving mode to the automated driving mode.

### SUMMARY

According to an aspect of the present disclosure, a vehicle switches from a without-monitoring-duty automated driving without a duty of monitoring by a driver to a with-monitoring-duty automated driving with the duty of monitoring by the driver. A display control unit causes a display device to display a surrounding state image that shows a surrounding state of the vehicle. A mode identification unit identifies whether automated driving in a hands-on mode, which requires gripping of a steering wheel of the vehicle, or automated driving in a hands-off mode, which does not require gripping of the steering wheel, is executed when the vehicle is in the with-monitoring-duty automated driving.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing an example of a schematic configuration of a vehicle system;

FIG. 2 is a diagram showing an example of a configuration of an HCU;

FIG. 3 is an explanatory view showing an example of a surrounding state image;

FIG. 4 is an explanatory view showing an example of a difference in a display mode of the surrounding state image between a hands-on mode and a hands-off mode;

FIG. 5 is an explanatory view showing an example of a difference in the display mode of the surrounding state image between a hands-on mode and a hands-off mode;

FIG. 6 is an explanatory view showing an example of a difference in the display mode of the surrounding state image between a hands-on mode and a hands-off mode;

FIG. 7 is an explanatory view showing an example of a difference in the display mode of the surrounding state image between a hands-on mode and a hands-off mode;

FIG. 8 is an explanatory view showing an example of a difference in the display mode of the surrounding state image between a hands-on mode and a hands-off mode;

FIG. 9 is an explanatory view showing an example of a difference in the display mode of the surrounding state image between a hands-on mode and a hands-off mode;

FIG. 10 is an explanatory view showing an example of a difference in the display mode of the surrounding state image between a hands-on mode and a hands-off mode;

FIG. 11 is an explanatory view showing an example of a difference in the display mode of the surrounding state image between a hands-on mode and a hands-off mode;

FIG. 12 is a flowchart showing an example of a flow of a first display control related process in the HCU according to a first embodiment;

FIG. 13 is a flowchart showing an example of a flow of a first display control related process in the HCU according to a second embodiment;

FIG. 14 is an explanatory view showing an example of a difference in the display mode of the surrounding state image between a hands-on mode and a hands-off mode;

FIG. 15 is a diagram showing an example of a configuration of the HCU;

FIG. 16 is an explanatory diagram showing a difference in timing of switching of display according to whether or not the surrounding state image is displayed in automated driving of the subject vehicle at level 3 or higher;

FIG. 17 is a diagram showing an example of a schematic configuration of a vehicle system;

FIG. 18 is a diagram showing an example of a configuration of an HCU;

FIG. 19 is a flowchart showing an example of a flow of a second display control related process in the HCU according to a sixth embodiment; and

FIG. 20 is a diagram showing an example of a configuration of an HCU.

### DETAILED DESCRIPTION

Hereinafter, examples of the present disclosure will be described. According to an example of the present disclosure, a vehicle is switched from a manual driving mode to an automated driving mode stepwise. In this example, a notification indicator indicates an automated level when a manual driving mode is switched to an automated mode stepwise.

For example, the automation level classified into levels 0 to 5 defined by SAE are known. Level 0 is a level where the driver performs all driving tasks without any intervention of the system. The level 0 corresponds to so-called manual driving. Level 1 is a level where the system assists steering or acceleration and deceleration. The level 2 is a level where the system assists steering and acceleration and deceleration. The automated driving at levels 1 and 2 is automated driving in which a driver has a duty of monitoring related to safe driving (hereinafter simply referred to as a duty of monitoring). The level 3 is a level where the system performs all driving tasks in a certain location, such as a highway, and the driver performs driving in an emergency. The level 4 is a level where the system is capable of performing all driving tasks, except under a specific circumstance, such as an unsupported road, an extreme environment, and the like. The level 5 is a level where the system is capable of performing all driving tasks in any states.

It is conceivable, not only switching from the manual driving mode to the automated driving mode, but also switching in the automated driving mode to the automated driving at a low level of automation. Herein, in a case where switching from level 3 or higher automated driving, which does not require the duty of monitoring, to the automated driving at level 2, which requires the duty of monitoring, even when the automation level is the same, an operation required of the driver may be different. Specifically, in the automated driving at level 2, it is conceivable to take a hands-on mode that requires gripping the steering wheel and a hands-off mode that does not require gripping the steering wheel. To his issue, a configuration that displays the automation level as in the above example cannot cause the driver to recognize whether the automated driving mode after the automation level is switched is the hands-on mode or the hands-off mode.

According to an example of the present disclosure, a vehicle display control device is to be used for a vehicle. The vehicle is configured to switch from a without-monitoring-duty automated driving without a duty of monitoring by a driver to a with-monitoring-duty automated driving with the duty of monitoring by the driver. The vehicle display control device comprises: a display control unit configured to cause a display device, which is to be used in an interior of the vehicle, to display a surrounding state image that is an image to show a surrounding state of the vehicle; a mode identification unit configured to identify whether automated driving in a hands-on mode, which requires gripping of a steering wheel of the vehicle, or automated driving in a hands-off mode, which does not require gripping of the steering wheel, is executed when the vehicle is in the with-monitoring-duty automated driving; and the display control unit is configured to, when the vehicle switches from the without-monitoring-duty automated driving to the with-monitoring-duty automated driving, differentiate display of the surrounding state image, depending on whether the mode identification unit identifies the automated driving in the hands-on mode or the automated driving in the hands-off mode.

According to an example of the present disclosure, a vehicle display control method is to be used for a vehicle. The vehicle is configured to switch from a without-monitoring-duty automated driving without a duty of monitoring by a driver to a with-monitoring-duty automated driving with the duty of monitoring by the driver. The vehicle display control method comprises: Each process is executed by at least one processor. causing a display device (91, 91b), which is to be used in an interior of the vehicle, to display a surrounding state image that is an image to show a surrounding state of the vehicle in a display control process; and identifying whether automated driving in a hands-on mode, which requires gripping of a steering wheel of the vehicle, or automated driving in a hands-off mode, which does not require gripping of the steering wheel, is executed when the vehicle is in the with-monitoring-duty automated driving in a mode identification process. The display control process includes, when the vehicle switches from the without-monitoring-duty automated driving to the with-monitoring-duty automated driving, differentiating display of the surrounding state image, depending on whether the mode identification process identifies the automated driving in the hands-on mode or the automated driving in the hands-off mode.

According to the configuration, display of the surrounding state image on the display device used in the passenger compartment of the vehicle is differentiated depending on whether to switch, from automated driving without the duty of monitoring, to automated driving in the hands-on mode or automated driving in the hands-off mode among automated driving with the duty of monitoring. Therefore, the driver of the vehicle is facilitated to recognize, from the difference in the display of the surrounding state image, whether to switch to automated driving in the hands-on mode or to switch to automated driving in the hands-off mode. Consequently, when the state in which automated driving without the monitoring duty is switched to the with-monitoring-duty automated driving, it is possible for the driver to easily recognize whether the automated driving after the switching is in the hands-on mode or in the hands-off mode.

According to an example of the present disclosure, a vehicle display control system is to be used for a vehicle. The vehicle is configured to switch from a without-monitoring-duty automated driving without a duty of monitoring by a driver to a with-monitoring-duty automated driving with the duty of monitoring by the driver. The vehicle display control system comprises: a display device to be provided to the vehicle so that a display surfaces is oriented to an interior of the vehicle; and the vehicle display control device.

This configuration includes the vehicle display control device. Therefore, when the without-monitoring-duty automated driving is switched to the with-monitoring-duty automated driving, it is possible for the driver to easily recognize whether the automated driving after the switching is in the hands-on mode or in the hands-off mode.

The following will describe embodiments of the present disclosure with reference to the accompanying drawings. For convenience of description, the same reference signs are assigned to portions having the same functions as those illustrated in the drawings used in the description so far among the plurality of embodiments, and a description of the same portions may be omitted. The description of other embodiments may be referred to with respect to these portions given the same reference symbols.

### First Embodiment

### Schematic Configuration of Vehicle System 1

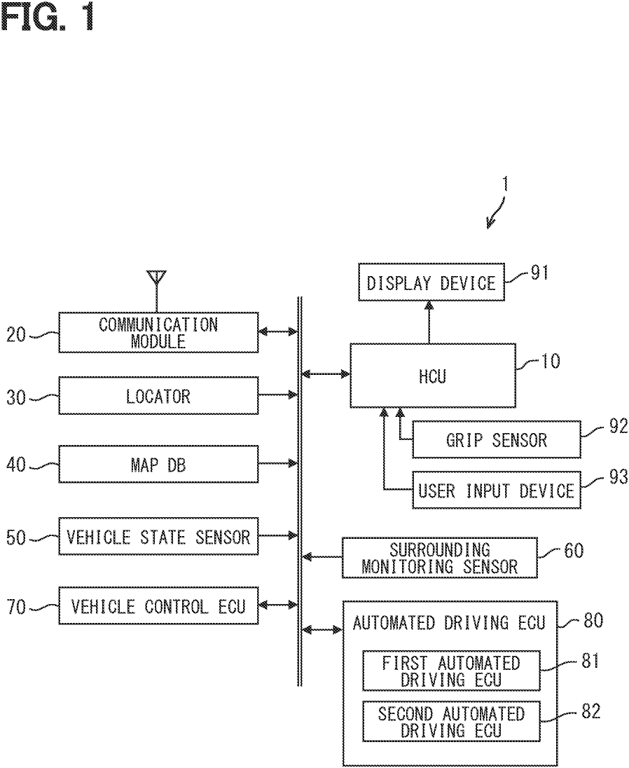

The following will describe a first embodiment of the present disclosure with reference to the accompanying drawings. A vehicle system 1 shown in FIG. 1 is used for a vehicle configured to perform automated driving (hereinafter referred to as an automated driving vehicle). As shown in FIG. 1, the vehicle system 1 includes an HCU (Human Machine Interface Control Unit) 10, a communication module 20, a locator 30, a map database (hereinafter referred to as map DB) 40, a vehicle state sensor 50, a surrounding monitoring sensor 60, a vehicle control ECU 70, an automated driving ECU 80, a display device 91, a grip sensor 92, and a user input device 93. The vehicle system 1 corresponds to a vehicle display control system. Although the vehicle using the vehicle system 1 is not necessarily limited to an automobile, hereinafter, an example using the automobile will be described.

The degree of the automated driving (hereinafter, referred to as an automation level) of an automated driving vehicle includes multiple levels as defined by, for example, SAE. This automation level is classified into, for example, five levels including level 0 to level 5 as follows.

Level 0 is a level where the driver performs all driving tasks without any intervention of the system. The driving task may be rephrased as a dynamic driving task. The driving tasks include, for example, steering, acceleration and deceleration, and surrounding monitoring. The level 0 corresponds to so-called manual driving. Level 1 is a level where the system assists steering or acceleration and deceleration. The levels 1 corresponds to so-called driving assistance. The level 2 is a level where the system assists steering and acceleration and deceleration. The level 2 corresponds to so-called partial driving automation. The levels 1 and 2 are a part of the automated driving.

For example, the automated driving at levels 1 and 2 is automated driving in which a driver has a duty of monitoring related to safe driving (hereinafter simply referred to as a duty of monitoring). The duty of monitoring includes visual monitoring of surroundings. The automated driving at levels 1 and 2 is, in other words, automated driving in which a second task is not permitted. The second task is an action other than a driving operation permitted to the driver, and is a predetermined specific action. The second task is, in other words, a secondary activity, another activity, or the like. The second task must not prevent a driver from responding to a request to take over the driving from the automated driving system. As an example, viewing of a content such as a video, operation of a smartphone, reading, and eating are assumed as the second task.

The level 3 is a level where the system performs all driving tasks in a certain location, such as a highway, and the driver performs driving in an emergency. In the level 3, the driver must be able to respond quickly when the system requests to take over the driving. This takeover of the driving can also be rephrased as transfer of the duty of monitoring of the surroundings from the system on the vehicle side to the driver. The level 3 corresponds to a conditional automated driving. The level 4 is a level where the system is capable of performing all driving tasks, except under a specific circumstance, such as an unsupported road, an extreme environment, and the like. The level 4 corresponds to a highly automated driving. The level 5 is a level where the system is capable of performing all driving tasks in any states. The level 5 corresponds to a fully automated driving.

For example, the automated driving at levels 3 to 5 is automated driving in which the driver does not have the duty of monitoring. The automated driving at levels 3 to 5 is, in other words, automated driving in which the second task is permitted. Among the automated driving at levels 3 to 5, the automated driving at level 4 or higher is automated driving in which the driver is permitted to sleep (hereinafter referred to as sleep-permitted automated driving). Among the automated driving at levels 3 to 5, the automated driving at level 3 is automated driving in which the driver is not permitted to sleep (hereinafter referred to as sleep-unpermitted automated driving). In the present embodiment, switching between the automation level at level 3 or higher and the automation level at level 2 or lower switches the presence or absence of the duty of monitoring. Therefore, when the automation level is switched from the automation level at level 3 or higher to the automation level at level 2 or lower, the driver is required of monitoring related to safe driving. On the other hand, for example, when the automation level at level 2 or higher is switched to the automation level at level 1 or lower, transfer of a driving control right may be required to the driver. In the present embodiment, a case in which the driving control right is transferred to the driver when automation level at level 2 or higher is switched to automation level at level 1 or lower will be described as an example.

The automated driving vehicle of the present embodiment is capable of switching the automation level. A configuration may be employable in which the automation level is switchable within a part of the levels 0 to 5. In this embodiment, a case in which the automated vehicle is capable of switching among automated driving at automation level 3, automated driving at automation level 2, and automated driving at automation level 1 or manual driving will be described as an example. In the present embodiment, for example, automated driving at automation level 3 is permitted only in a traffic jam. In addition, in this embodiment, a configuration may be employable in which automated driving at automation level 3 is permitted only when driving in a traffic jam and when driving on in a specific road section such as an expressways or a motorway. In the following, a case in which automated driving at automation level 3 is permitted only when driving in a traffic jam and when driving on in a specific road section such as an expressways or a motorway will be described.

Further, in this embodiment, automated driving at automation level 2 includes a hands-on mode automated driving that requires gripping of the steering wheel of the subject vehicle and a hands-off mode automated driving that does not require gripping of the steering wheel of the subject vehicle. As an example, the hands-on mode and the hands-off mode can be selectively used as follows. For example, when switching from automation level 3 to automation level 2 is scheduled based on a state that can be predicted in advance, a configuration may be employable to switch to automated driving in the hands-off mode. On the other hand, when switching from automation level 3 to automation level 2 is unscheduled (i.e. sudden) based on a state that cannot be predicted in advance, a configuration may be employable to switch to automated driving in the hands-on mode. When the switching from automation level 3 to automation level 2 is sudden, there is a high possibility that relatively intense vehicle behavior will occur. Thus, it is conceivable that there is a high need for the driver to grip the steering wheel. Note that automated driving at automation level 1 corresponds to hands-on mode automated driving.

The configuration is not limited to the above examples. The hands-on mode and the hands-off mode may be selectively used depending on whether a high-precision map data exists or not. For example, hands-off mode may be used in a section where the high-definition map data exists. On the other hand, the hands-on mode may be used in a section where the high-precision map data does not exist. The high-precision map data will be described later. Alternatively, the hands-on mode and the hands-off mode may be selectively used depending on whether or not the subject vehicle is approaching a specific point. For example, the hands-off mode may be selected when the subject vehicle is not approaching the specific point. The hands-on mode may be selected when the subject vehicle is approaching the specific point. Whether or not the subject vehicle is approaching the specific point may be determined based on whether or not the distance to the specific point is equal to or less than an arbitrary predetermined value. Examples of the specific point may include a toll booth in the specific road section described above, an exit in the specific road section described above, a merging point, an intersection, a two-way traffic section, a point where the number of lanes decreases, and the like. The specific point may also be rephrased as a point where it is estimated that there is a higher possibility that the driver will need to grip the steering wheel.

The communication module 20 transmits and receives information to and from other vehicles via wireless communications. In other words, the communication module 20 performs vehicle-to-vehicle communications. The communication module 20 may transmit and receive information via wireless communications with a roadside device installed on a roadside. In other words, the communication module 20 may perform road-to-vehicle communications. When performing the road-to-vehicle communications, the communication module 20 may receive information about a surrounding vehicle transmitted from the surrounding vehicle via the roadside device. Further, the communication module 20 may transmit and receive information to and from a center outside the subject vehicle via wireless communications. In other words, the communication module 20 may perform wide area communications. When performing the wide area communications, the communication module 20 may receive information about a surrounding vehicle transmitted from the surrounding vehicle via the center. In addition, when performing the wide area communications, the communication module 20 may receive traffic jam information, weather information, and the like around the subject vehicle from the center.

The locator 30 includes a GNSS (Global Navigation Satellite System) receiver and an inertial sensor. The GNSS receiver receives positioning signals from multiple positioning satellites. The inertial sensor includes, for example, a gyro sensor and an acceleration sensor. The locator 30 combines the positioning signals received by the GNSS receiver with a measurement result of the inertial sensor to sequentially detect the position of the subject vehicle (hereinafter, subject vehicle position) of the subject vehicle on which the locator 30 is mounted. The subject vehicle position may be represented by, for example, coordinates of latitude and longitude. The subject vehicle position may be measured by using a travel distance acquired from signals sequentially output from a vehicle speed sensor mounted on the vehicle.

The map DB 40 is a non-volatile memory and stores the high-precision map data. The high-precision map data is map data with higher precision than the map data used for route guidance in a navigation function. The map DB 40 may also store map data used for route guidance. The high-precision map data includes information that can be used for automated driving, such as three-dimensional road shape information, information on the number of lanes, and information indicating the direction of travel allowed for each lane. In addition, the high-definition map data may also include a node point information indicating the positions of both ends of a road marking such as a lane marking. Note that the locator 30 may be configured without the GNSS receiver by using the three-dimensional shape information of the road. For example, the locator 30 may be configured to identify the subject vehicle position by using the three-dimensional shape information of the road and a LiDAR (Light Detection and Ranging/Laser Imaging Detection and Ranging) that detects feature points of the road shape and the building or the surrounding monitoring sensor 60 such as a surrounding monitoring camera. The three-dimensional shape information of the road may be generated based on a captured image by REM (Road Experience Management).

The communication module 20 may receive map data distributed from an external server through, for example, wide area communications and may store the data in the map DB 40. In this case, the map DB 40 may be stored in a volatile memory, and the communication module 20 may sequentially acquire the map data of an area corresponding to the subject vehicle position.

The vehicle state sensor 50 is a sensor group for detecting various states of the subject vehicle. The vehicle state sensor 50 includes a vehicle speed sensor for detecting a vehicle speed, a steering sensor for detecting a steering angle, and the like. The vehicle state sensor 50 outputs detected sensing information to the in-vehicle LAN. Note that the sensing information detected by the vehicle state sensor 50 may be output to an in-vehicle LAN via an ECU mounted on the subject vehicle.

The surrounding monitoring sensor 60 monitors a surrounding environment of the subject vehicle. For example, the surrounding monitoring sensor 60 detects an obstacle around the subject vehicle, such as a pedestrian, a moving object like another vehicle, and a stationary object, such as an object on the road. The surrounding monitoring sensor 60 further detects a road surface marking such as a traffic lane marking around the subject vehicle. The surrounding monitoring sensor 60 is a sensor such as a surrounding monitoring camera that captures a predetermined range around the subject vehicle, a millimeter wave radar that transmits a search wave in a predetermined range around the subject vehicle, a sonar, or a LiDAR. The surrounding monitoring camera sequentially outputs, as sensing information, sequentially captured images to the automated driving ECU 80. A sensor that transmits a probe wave such as a sonar, a millimeter wave radar, a LiDAR or the like sequentially outputs, as the sensing information to the automated driving ECU 80, a scanning result based on a received signal acquired as a wave reflected on an obstacle on the road. The sensing information detected by the surrounding monitoring sensor 60 may be outputted to the in-vehicle LAN via the automated driving ECU 80.

The vehicle control ECU 70 is an electronic control device configured to perform a traveling control of the subject vehicle. The traveling control includes an acceleration and deceleration control and/or a steering control. The vehicle control ECU 70 includes a steering ECU that performs the steering control, a power unit control ECU and a brake ECU that perform the acceleration and deceleration control, and the like. The vehicle control ECU 70 is configured to output a control signal to a traveling control device such as an electronic throttle, a brake actuator, and an EPS (Electric Power Steering) motor mounted on the subject vehicle thereby to perform the traveling control.

The automated driving ECU 80 includes, for example, a processor, a memory, an I/O, and a bus that connects those devices, and executes a control program stored in the memory thereby to execute a process related to the automated driving. The memory referred to here is a non-transitory tangible storage medium, and stores programs and data that can be read by a computer. The non-transitory tangible storage medium is a semiconductor memory, a magnetic disk, or the like.

The automated driving ECU 80 includes a first automated driving ECU 81 and a second automated driving ECU 82. The following description is given assuming that each of the first automated driving ECU 81 and the second automated driving ECU 82 includes a processor, a memory, an I/O, and a bus connecting these devices. A configuration may be employable in which a common processor bears the function of the first automated driving ECU81 and the second automated driving ECU82 by a virtualization technology.

The first automated driving ECU 81 bears the function of the automated driving at level 2 or lower as described above. In other words, the first automated driving ECU 81 enables the automated driving that requires the duty of monitoring. For example, the first automated driving ECU 81 is capable of executing at least one of a longitudinal direction control in a longitudinal direction and a lateral direction control in a lateral direction of the subject vehicle. The longitudinal direction is a direction that coincides with a longitudinal direction of the subject vehicle. The lateral direction is a direction that coincides with a lateral direction of the subject vehicle. The first automated driving ECU 81 executes, as the longitudinal direction control, the acceleration and deceleration control of the subject vehicle. The first automated driving ECU 81 executes, as the lateral direction control, the steering control of the subject vehicle. The first automated driving ECU 81 includes, as functional blocks, a first environment recognition unit, an ACC control unit, an LTA control unit, an LCA control unit, and the like.

The first environment recognition unit recognizes a driving environment around the subject vehicle based on the sensing information acquired from the surrounding monitoring sensor 60. As an example, the first environment recognition unit recognizes a detailed position of the subject vehicle in a driving lane (hereinafter, subject vehicle lane) from information such as left and right lane markings of the driving lane in which the subject vehicle travels. In addition, the first environment recognition unit recognizes a position and a velocity of an obstacle such as a vehicle around the subject vehicle. The first environment recognition unit recognizes the position and the speed of an obstacle such as a vehicle in the subject vehicle lane. In addition, the first environment recognition unit recognizes the position and speed of an obstacle such as a vehicle in a surrounding lane of the subject vehicle lane. The surrounding lane may be, for example, a lane adjacent to the subject vehicle lane. Alternatively, the surrounding lane may be a lane other than the subject vehicle lane in a road section where the subject vehicle is located. Note that the first environment recognition unit may have the same configuration as the second environment recognition unit described later.

The ACC control unit executes an ACC control (Adaptive Cruise Control) to perform constant-speed traveling of the subject vehicle at a target speed or following travel with respect to the preceding vehicle. The ACC control unit may perform ACC control using the position and the velocity of the vehicle around the subject vehicle recognized by the first environment recognition unit. The ACC control unit may cause the vehicle control ECU 70 to perform the acceleration and deceleration control thereby to perform the ACC control.

An LTA control unit executes an LTA (Lane Tracing Assist) control to maintain the subject vehicle to drive within the lane. The LTA control unit may perform the LTA control using the detailed position of the subject vehicle in the subject vehicle lane recognized by the first environment recognition unit. The LTA control unit may cause the vehicle control ECU 70 to perform the steering control thereby to perform the LTA control. Note that the ACC control is an example of the longitudinal direction control. The LTA control is an example of the lateral direction control.

The LCA control unit performs an LCA (Lane Change Assist) control for automatically changing the lane of the subject vehicle from the subject vehicle lane to an adjacent lane. The LCA control unit may perform LCA control using the position and the velocity of the vehicle around the subject vehicle recognized by the first environment recognition unit. For example, the LCA control may be executed when the speed of a vehicle ahead of the subject vehicle is lower than a predetermined value and when there is no surrounding vehicle approaching from the side of the subject vehicle to the rear side. For example, the LCA control unit may perform the LCA control by causing the vehicle control ECU 70 to perform the acceleration/deceleration control and the steering control.

The first automated driving ECU 81 performs both the ACC control and the LTA control thereby to realize the automated driving at level 2. The LCA control may allowed to be executed, for example, when the ACC control and the LTA control are executed. The first automated driving ECU 81 may perform either the ACC control or the LTA control thereby to realize the automated driving at level 1.

On the other hand, the second automated driving ECU 82 bears the function of the automated driving at level 3 or higher. In other words, the second automated driving ECU 82 enables the automated driving that does not require the duty of monitoring. The second automated driving ECU 82 includes, as functional blocks, a second environment recognition unit, an action determination unit, a trajectory generation unit, and the like.

The environment recognition unit recognizes the driving environment around the subject vehicle based on the sensing information, which is acquired from the surrounding monitoring sensor 60, the subject vehicle position, which is acquired from the locator 30, the map data, which is acquired from the map DB 40, the vehicle information, which acquired by the communication module 20, and the like. As an example, the second environment recognition unit uses these pieces of information to generate a virtual space that reproduces an actual driving environment.

The second environment recognition unit determines a manual driving area (hereinafter referred to as an MD area) in a travelling area of the subject vehicle. The second environment recognition unit determines an automated driving area (hereinafter referred to as an AD area) in the travelling area of the subject vehicle. The second environment recognition unit determines an ST section in the AD area. The second environment recognition unit determines a non-ST section in the AD area.

The MD area is an area where the automated driving is prohibited. In other words, the MD area is an area where the driver performs all of the longitudinal control, lateral control and surrounding monitoring of the subject vehicle. For example, the MD area may be an ordinary road.

The AD area is an area where the automated driving is permitted. In other words, the AD area is an area where the subject vehicle is capable of performing at least one of the longitudinal control, the lateral control, and the surrounding monitoring, instead of the driver. For example, the AD area may be a highway or a motorway.

The AD area is classified into a non-ST section, in which the automated driving at level 2 or lower is permitted, and an ST section, in which the automated driving at level 3 or higher is permitted. In the present embodiment, the non-ST section, in which the automated driving at level 1 is permitted, and the non-ST section, in which the automated driving at level 2 is permitted, are not classified. The ST section may be, for example, a traveling section in which a traffic jam occurs (hereinafter, a traffic jam section). Further, the ST section may be, for example, a traveling section in which a high-precision map date is prepared. The non-ST section may be a section other than the ST section.

The action determination unit determines an action, which is scheduled for the subject vehicle (hereinafter referred to as a future action), based on a recognition result of the driving environment by the second environment recognition unit and the like. The action determination unit determines a future action for causing the subject vehicle to perform the automated driving. The action determination unit may determine, as the future action, a type of action that the subject vehicle should take in order to arrive at a destination. This type includes, for example, going straight, turning right, turning left, and changing lanes.

Further, when the action determination unit determines that takeover of driving is necessary, the action determination unit generates a request for takeover of driving and outputs the request to the HCU 10. One example of a case where the takeover of driving is required is a case where the subject vehicle moves from an ST section in the AD area to the non-ST section. Another example of a case where the takeover of driving is required is a case where the subject vehicle moves from the ST section of the AD area to the MD area. Another cause of the takeover of driving (hereinafter referred to as a takeover cause) includes elimination of traffic jam and lack of the high-precision map data.

Shortage of the high-definition map data is predictable. The action determination unit may predict the lack of the high-precision map data for the scheduled route of the subject vehicle using the vehicle position measured by the locator 30 and the high-precision map data stored in the map DB 40. When the behavior determination unit predicts lack of the high-precision map data, the behavior determination unit may determine that the takeover of driving is necessary. In this case, the behavior determination unit may output the request for takeover of driving to the HCU 10 before the subject vehicle reaches a point where lack of the high-precision map data is predicted.

Elimination of traffic jam may be predictable or unpredictable. More specifically, when the communication module 20 is capable of receiving traffic jam information and information on a surrounding vehicle, the communication module 20 is capable of predicting the elimination of the traffic jam from these pieces of information. The action determination unit may predict elimination of traffic jam on the scheduled route of the subject vehicle using the vehicle position measured by the locator 30 and the traffic jam information received by the communication module 20. In addition, the behavior prediction unit may use a number and speed of surrounding vehicles specified from the information on the surrounding vehicles received by the communication module 20 to predict the elimination of traffic jam on the scheduled route of the subject vehicle. Then, the action determination unit may determine that the takeover of driving is necessary when the traffic jam is predicted to be eliminated.

On the other hand, when the communication module 20 cannot receive the traffic jam information and the information about the surrounding vehicles, it is assumed that the traffic jam cannot be predicted. When it is not possible to predict that the traffic jam will be eliminated, the number of surrounding vehicles, the speed of the surrounding vehicle, and the like recognized by the second environment recognition unit using the surrounding monitoring sensor 60 may be used to determine whether the traffic jam will be eliminated. Then, the action determination unit may determine that the takeover of driving is necessary when the traffic jam is determined to be eliminated.

In addition, there is a case where the takeover off driving is required other than elimination of traffic jam and lack of the high-precision map data. For example, a change in a road structure, sudden sensor loss, sudden bad weather, and the like can be considered. A change in the road structure that requires the takeover of driving includes an end of a section with a median strip, a decrease in the number of lanes, and entry into a construction section. The reason why these changes in the road structure cause the takeover of driving is that there is a possibility that an accuracy of recognizing the driving environment will decrease. The change in the road structure is predictable. The action determination unit may predict change in the road structure, such as the end of a section of the scheduled route of the subject vehicle with a median strip and decrease in the number of lanes, using the vehicle position measured by the locator 30 and the high-precision map data stored in the map DB 40. In addition, the action determination unit may predict change in the road structure such as the subject vehicle entering a construction section, based on presence of a signboard under construction recognized by the second environment recognition unit using the surrounding monitoring sensor 60. Then, the action determination unit may determine that the takeover of driving is necessary when these changes in the road structure are predicted.

Sudden sensor loss is a failure of the surrounding monitoring sensor 60, a failure of recognition of the driving environment using the surrounding monitoring sensor 60, and the like. The sudden bad weather includes heavy rain, snow, fog, and the like. The reason why sudden bad weather causes the takeover of driving is that there is a possibility that the recognition accuracy of the driving environment using the surrounding monitoring sensor 60 is lowered. Another reason why sudden bad weather may cause the takeover of driving is that there is a possibility that failure in communications would occur in the communication module 20. Sudden sensor loss and sudden bad weather cannot be predicted. The action determination unit may determine sudden sensor loss and sudden bad weather from a recognition result of the driving environment by the second environment recognition unit. Further, the action determination unit may determine that the takeover of driving is necessary when determining sudden sensor loss or sudden bad weather.

The trajectory generation unit generates the travel trajectory of the subject vehicle in a section, in which the automated driving can be performed, based on the recognition result of the driving environment by the second environment recognition unit and the future action determined by the action determination unit. The travel trajectory includes, for example, a target position of the subject vehicle according to a progress, a target speed at each target position, and the like. The trajectory generation unit sequentially provides the generated travel trajectory, as a control command to be followed by the subject vehicle in the automated driving, to the vehicle control ECU 70.

With the automated driving system including the automated driving ECU 80, the automated driving at level 2 or lower and the automated driving at level 3 or higher can be executed in the subject vehicle. Further, for example, the automated driving ECU 80 may be configured to switch the automation level of the automated driving of the subject vehicle as necessary. As an example, the automated driving at level 3 may be switched to the automated driving at level 2 or lower, when the subject vehicle moves from the ST section to the non-ST section in the AD area. Further, the automated driving ECU 80 may switch from the automated driving at level 3 to manual driving when the subject vehicle moves from the ST section in the AD area to the MD area.

When a cause for switching from the automated driving at level 3 to the automated driving at level 2 occurs and when the cause for the switching has been predicted, the automated driving ECU 80 may select the hands-off mode at the automated driving at level 2. Alternatively, when the cause for switching from the automated driving at level 3 to the automated driving at level 2 occurs and when the cause for the switching has not been predicted, the automated driving ECU 80 may select the hands-on mode at the automated driving at level 2. In addition, when the automated driving at level 3 is switched to the automated driving at level 1, the automated driving is switched to the automated driving in the hands-on mode. For example, the action determination unit may determine whether the automated driving is switched to the hands-on mode or the hands-off mode due to the takeover of driving.

The display device 91 is a display device provided to the subject vehicle. The display device 91 is provided so that a display surface faces an interior of the subject vehicle. For example, the display device 91 is provided so that the display surface is positioned in front of the driver seat of the subject vehicle. As the display device 91, various displays, such as a liquid crystal display, an organic EL display, and a head-up display (hereinafter referred to as an HUD), may be used.

The grip sensor 92 detects gripping of the steering wheel of the subject vehicle by the driver. The grip sensor 92 may be provided on a rim portion of the steering wheel. The user input device 93 accepts input from the user. The user input device 93 may be an operation device that receives operation input from the user. The operation device may be a mechanical switch or a touch switch integrated with the display device. It should be noted that the user input device 93 is not limited to the operation device that accepts the operation input, as long as the user input device 93 is a device that accepts input from the user. For example, the user input device 93 may be a voice input device that receives command input by voice from the user.

The HCU 10 is mainly composed of a computer including a processor, a volatile memory, a nonvolatile memory, an I/O, and a bus connecting these devices. The HCU 10 is connected to the display device 91 and the in-vehicle LAN. The HCU 10 executes a control program stored in the nonvolatile memory, thereby to control indication of the display device 91. The HCU 10 corresponds to a vehicle display control device. The configuration of the HCU 10 for controlling indication of the display device 91 will be described in detail below.

### Schematic Configuration of HCU 10

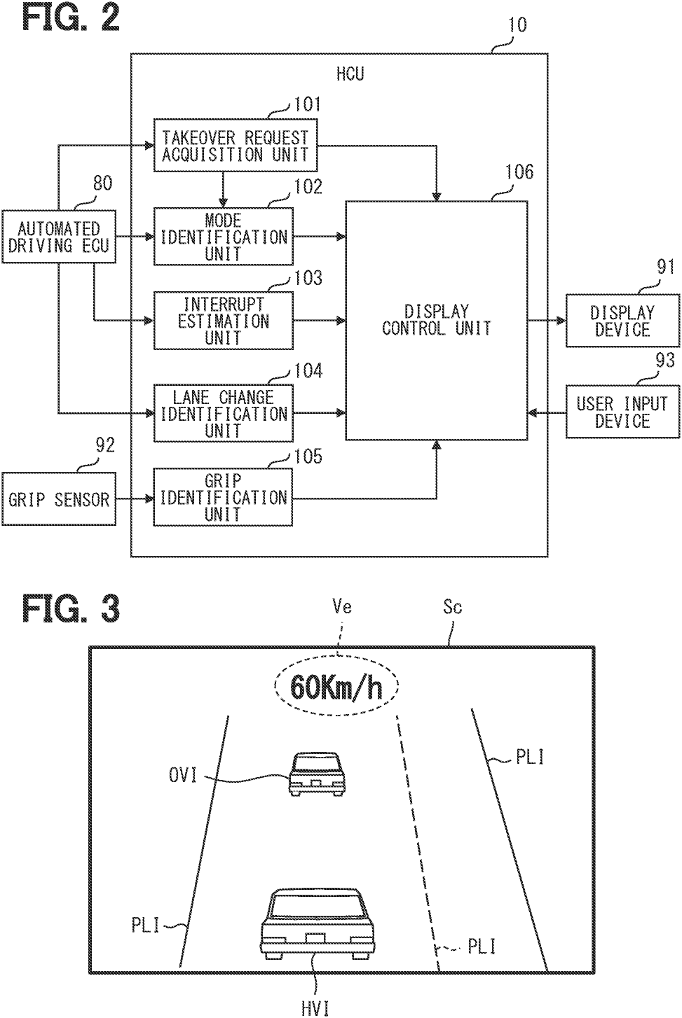

Herein, a schematic configuration of the HCU 10 will be described with reference to FIG. 2. As shown in FIG. 2, the HCU 10 includes, as functional blocks, a takeover request acquisition unit 101, a mode identification unit 102, an interrupt estimation unit 103, a lane change identification unit 104, a grip identification unit 105, and a display control unit 106 for the control of the indication on the display device 91. Execution of a process of each functional block of the HCU 10 by the computer corresponds to execution of a vehicle display control method. Some or all of the functions executed by the HCU 10 may be produced by hardware using one or more ICs or the like. Alternatively, some or all of the functions executed by the HCU 10 may be implemented by a combination of execution of software by a processor and a hardware device.

The takeover request acquisition unit 101 acquires a takeover request output from the automated driving ECU 80. When the takeover request is output from the automated driving ECU 80, the takeover request acquisition unit 101 acquires the takeover request.

The mode identification unit 102 identifies whether the subject vehicle performs the automated driving at level 2 or lower in the hands-on mode or in the hands-off mode. The process in this mode identification unit 102 corresponds to a mode identification process. The automated driving at level 2 or lower may be rephrased as a with-monitoring-duty automated driving. The mode identification unit 102 may perform the above identification based on the result of the determination by the action determination unit of the automated driving ECU 80 whether to switch the automated driving to be in the hands-on mode or the hands-off mode due to the takeover of driving. The mode identification unit 102 may maintain the identification result described above until the automation level of the subject vehicle is switched. In addition, the mode identification unit 102 may identify the automated driving in the hands-on mode when the automated driving at the level 2 in the hands-off mode is switched to the automated driving at the level 1.

The interrupt estimation unit 103 estimates interruption of a surrounding vehicle of the subject vehicle into the s driving lane of the subject vehicle (that is, the subject vehicle’s lane). The interrupt estimation unit 103 may estimate that interruption of a surrounding vehicle into the subject vehicle lane arises, for example, from the recognition result of the surrounding vehicle of the subject vehicle in the driving environment recognized by the first environment recognition unit of the automated driving ECU 80. For example, when acceleration of the surrounding vehicle toward the subject vehicle lane becomes equal to or greater than a threshold value, the interrupt estimation unit 103 may estimate that the surrounding vehicle is to cut into the subject vehicle lane. Further, the interrupt estimation unit 103 may estimate from the lighting of a blinker lamp of the surrounding vehicle on the side of the subject vehicle lane that the surrounding vehicle is to interrupt the subject vehicle lane. The lighting of the blinker lamp of the surrounding vehicle may be recognized by the first environment recognition unit through image analysis of an image captured by the surrounding monitoring camera. In addition, when the information about a surrounding vehicle received by the communication module 20 includes information that indicates that the surrounding vehicle is to interrupt the subject vehicle lane, the interrupt estimation unit 103 may estimate that interruption of the surrounding vehicle into the subject vehicle lane arises using this information.

The lane change identification unit 104 identifies that the subject vehicle is to change the lane by automated driving. The lane change identification unit 104 may identify that the subject vehicle changes the lane by the automated driving from, for example, the LCA control unit of the automated driving ECU 80 executing the LCA control.

The grip identification unit 105 identifies gripping of the steering wheel of the subject vehicle by the driver. For example, the grip identification unit 105 may identify the driver’s grip on the steering wheel from a detection result of the grip sensor 92. Note that the grip identification unit 105 may identify the grip of the steering wheel by the driver from information other than the detection result of the grip sensor 92. For example, driver’s grip on the steering wheel may be identified by performing image recognition on an image of the driver captured by a DSM (Driver Status Monitor).

The display control unit 106 controls display on the display device 91. Processing by the display control unit 106 corresponds to a display control process. The display control unit 106 causes the display device 91 to display an image (hereinafter referred to as a surrounding state image) for showing a surrounding state of the subject vehicle in the automated driving at level 2 or lower or in manual driving. The display control unit 106 may cause the display device 91 to display the surrounding state image as a bird’s-eye view image showing a positional relationship between the subject vehicle and a surrounding vehicle, viewed from a virtual viewpoint above the subject vehicle, using the positional relationship between the subject vehicle and the surrounding vehicle in the driving environment recognized by the automated driving ECU 80. This virtual viewpoint may be directly above the subject vehicle, or may be at a position deviated from directly above the subject vehicle. For example, the virtual viewpoint may be a bird’s-eye view viewed from a virtual viewpoint above and behind the subject vehicle. The image of the surrounding state may be a virtual image showing the surrounding state of the subject vehicle, or may be a processed image taken by the surrounding monitoring camera of the surrounding monitoring sensor 60.

An example of the surrounding state image will now be described with reference to FIG. 3. Sc in FIG. 3 indicates a display screen of the display device 91. PLI in FIG. 3 shows an image representing a lane marking (hereinafter referred to as a lane marking image). HVI in FIG. 3 shows an image representing the subject vehicle (hereinafter referred to as the subject vehicle image). OVI in FIG. 3 shows an image representing a surrounding vehicle of the subject vehicle (hereinafter referred to as a surrounding vehicle image). FIGS. 3 to 11 show examples in which the surrounding vehicle is a preceding vehicle of the subject vehicle. Ve in FIG. 3 shows an image representing a vehicle speed of the subject vehicle (hereinafter referred to as a vehicle speed image).

As shown in FIG. 3, the surrounding state image includes the subject vehicle image, the surrounding vehicle image, the lane marking image, and the vehicle speed image. The subject vehicle image, the surrounding vehicle image, the lane marking image, and the vehicle speed image correspond to image elements of the surrounding state image. As shown in FIG. 3, the surrounding state image may include an image element other than the subject vehicle image, the surrounding vehicle image, and the lane marking image, which are images showing the surrounding state of the subject vehicle.

When an image representing a foreground of the subject vehicle is used as the surrounding state image, the subject vehicle image may not be included in the surrounding state image. Further, the surrounding state image may include an image element such as an assistance implementation image, a hands-on-off image, and a background image. The assistance implementation image is an image showing a control related to driving assistance being implemented in the subject vehicle. An example of the control related to the driving assistance includes the above-described ACC control and the LTA control. The hands-on-off image is an image showing whether the subject vehicle is automatically driving in the hands-on mode or in the hands-off mode. The background image is an image showing a background among the surrounding state image.

On the other hand, for example, the display control unit 106 may cause the display device 91 to display an image explaining an action permitted as a second task, an image showing the speed of the subject vehicle, or the like, without displaying the surrounding state image, when the subject vehicle is in the automated driving at level 3 or higher. As another example of not displaying the surrounding state image, there is an example in which the subject vehicle image and the lane marking image corresponding to the subject vehicle lane are displayed, but the surrounding vehicle image is not displayed. This means that the surrounding vehicle image is not displayed even when the surrounding vehicle is detected by the surrounding monitoring sensor 60.

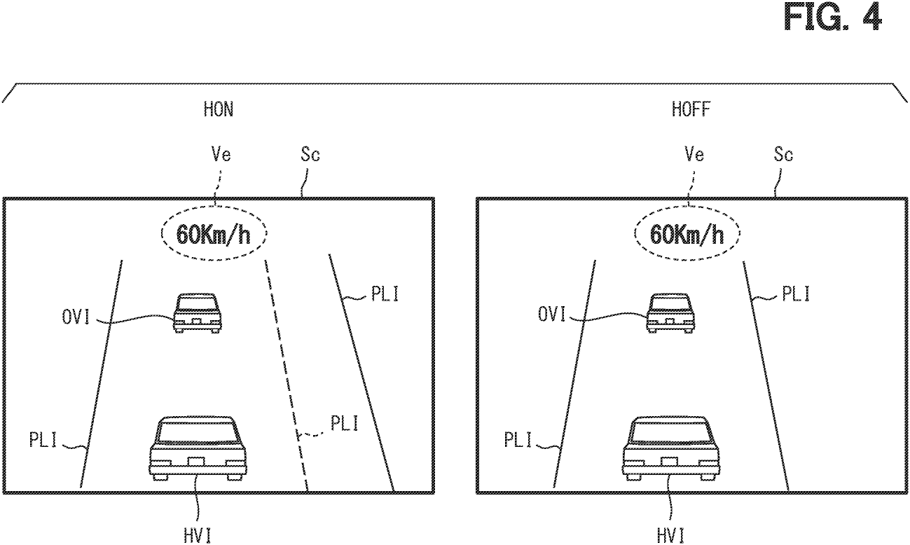

The display control unit 106 differentiates display of the surrounding state image depending on whether the mode identification unit 102 identifies the automated driving in the hands-on mode or the automated driving in the hands-off mode, when the subject vehicle switches from the automated driving at level 3 to the automated driving at level 2 or lower. The automated driving at automation level 3 may be rephrased as a without-monitoring-duty automated driving. As follows, an example of a difference in a display mode of the surrounding state image between the hands-on mode and the hands-off mode, when the subject vehicle switches from the automated driving at level 3 to the automated driving at level 2, will be described with reference to FIGS. 4 to 11. HON in FIGS. 4 to 11 shows the display mode in the hands-on mode. On the other hand, HOFF in FIGS. 4 to 11 shows the display mode in the hands-off mode.

When the mode identification unit 102 identifies the hands-on mode of automated driving, the display control unit 106 may display the subject vehicle lane and a surrounding lane. On the other hand, when the mode identification unit 102 identifies the automated driving in the hands-off mode, only the subject vehicle lane, among the subject vehicle lane and the surrounding lane, may be displayed. The surrounding lane may be, for example, a lane adjacent to the subject vehicle lane. Alternatively, the surrounding lane may be a lane other than the subject vehicle lane in a road section where the subject vehicle is located. As a specific example, as shown in FIG. 4, in the hands-on mode, both the lane marking images of the subject vehicle lane and the surrounding lane may be displayed. On the other hand, in the hands-off mode, only the lane marking image of the subject vehicle lane, among the subject vehicle lane and the surrounding lane, may be displayed.

In the hands-off mode, where safety is more likely to be ensured than in the hands-on mode, it is considered to be sufficient for the driver to know the state close to the subject vehicle. Conversely, in the hands-on mode, it is considered that the driver requires to know the state farther away from the subject vehicle. On the other hand, according to the above configuration, when the subject vehicle is in the hands-on mode, more lane states are displayed than when the subject vehicle is in the hands-off mode. Therefore, it is possible to display the surrounding state image in a display mode according to whether the subject vehicle is in the hands-on mode or in the hands-off mode. In addition, the number of lanes displayed in the surrounding state image can be differentiated depending on whether the subject vehicle is in the hands-on or in the hands-off mode. Therefore, from this difference, the driver of the subject vehicle is enabled to more easily recognize whether to switch to the automated driving in the hands-on mode or the automated driving in the hands-off mode.

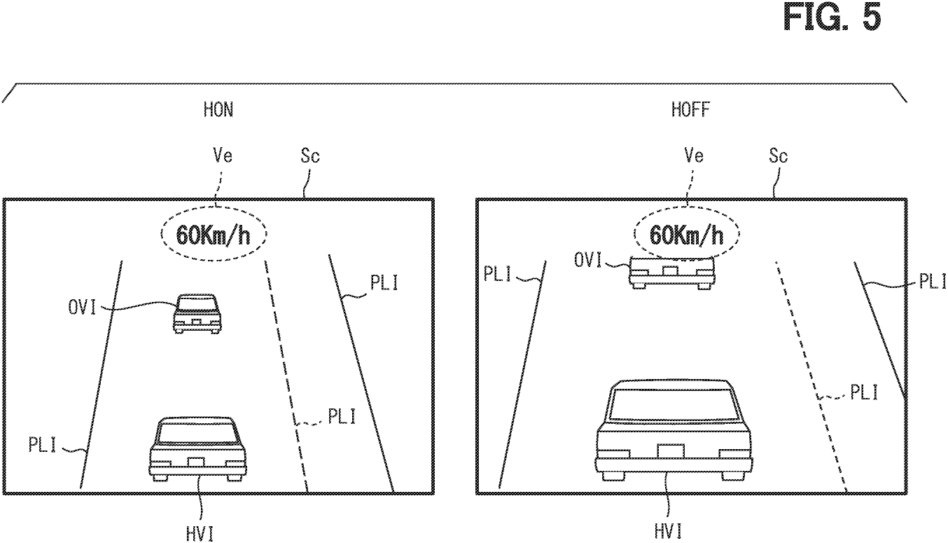

When the mode identification unit 102 identifies the automated driving in the hands-on mode, the display control unit 106 may display the surrounding state image viewed from a virtual viewpoint farther away from an object to be displayed in the surrounding state image, than when the mode identification unit 102 identifies the automated driving in the hands-off mode. The surrounding state image viewed from the virtual viewpoint farther away from an object to be displayed in the surrounding state image may be displayed. On the other hand, when the mode identification unit 102 identifies the automated driving in the hands-off mode, the surrounding state image viewed from a virtual viewpoint closer to the display target than when the mode identification unit 102 identifies the automated driving in the hands-on mode may be displayed. The display object referred to here is an object, the marking line, or the like shown in the surrounding state image. As a specific example, as shown in FIG. 5, in the hands-on mode, the surrounding state of the subject vehicle as seen from a farther distance than in the hands-off mode may be displayed. On the other hand, in the hands-off mode, the surrounding image of the subject vehicle as seen from a closer distance than in the hands-on mode may be displayed.

According to the above configuration, when the subject vehicle is in the hands-on mode, the state in a wider range than when the subject vehicle is in the hands-off mode is displayed. Therefore, it is possible to display the surrounding state image in a display mode according to whether the subject vehicle is in the hands-on mode or in the hands-off mode. In addition, depending on whether the subject vehicle is in the hands-on mode or the hands-off mode, the far/close of the virtual viewpoint of the surrounding state image is differentiated. Therefore, from this difference, the driver of the subject vehicle is enabled to more easily recognize whether to switch to the automated driving in the hands-on mode or the automated driving in the hands-off mode.

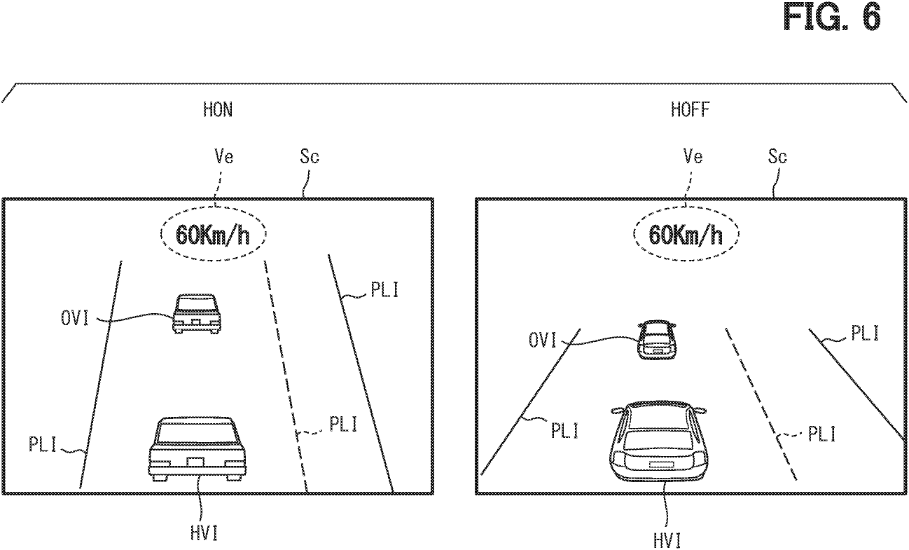

When the mode identification unit 102 identifies the automated driving in the hands-on mode, the display control unit 106 may display the surrounding state image viewed from a virtual viewpoint that further looks down from an upper position, than when the mode identification unit 102 identifies the automated driving in the hands-off mode. On the other hand, when the mode identification unit 102 identifies the automated driving in the hands-off mode, the display control unit 106 may display the surrounding state image viewed from a virtual viewpoint that looks down from a lower position, than when the mode identification unit 102 identifies the automated driving in the hands-on mode. As a specific example, as shown in FIG. 6, in the hands-on mode, the state of the subject vehicle as seen from a higher view point than in the hands-off mode may be displayed. On the other hand, in the hands-off mode, the surrounding image of the subject vehicle as seen from a lower position than in the hands-on mode may be displayed.

According to the above configuration, when the subject vehicle is in the hands-on mode, the state in a wider range than when the subject vehicle is in the hands-off mode is displayed. Therefore, it is possible to display the surrounding state image in a display mode according to whether the subject vehicle is in the hands-on mode or in the hands-off mode. In addition, depending on whether the subject vehicle is in the hands-on mode or the hands-off mode, the high/low of the virtual viewpoint of the surrounding state image is differentiated. Therefore, from this difference, the driver of the subject vehicle is enabled to more easily recognize whether to switch to the automated driving in the hands-on mode or the automated driving in the hands-off mode.

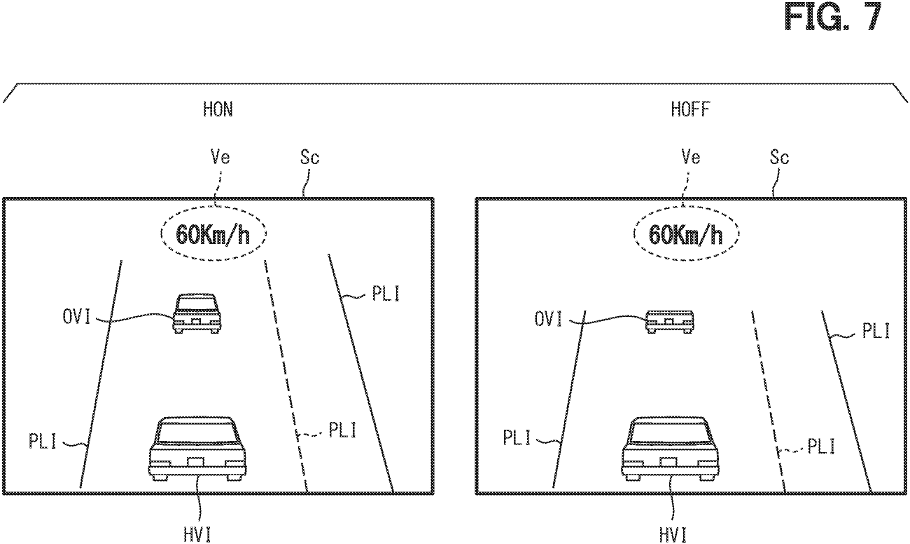

When the mode identification unit 102 identifies the automated driving in the hands-on mode, the display control unit 106 may enlarge a region of the surrounding of the subject vehicle displayed as the surrounding state image more than when the mode identification unit 102 identifies the automated driving in the hands-off mode. On the other hand, when the mode identification unit 102 identifies the automated driving in the hands-off mode, the display control unit 106 may reduce the region around the subject vehicle displayed as the surrounding state image, more than when the mode identification unit 102 identifies the automated driving in the hands-on mode. As a specific example, as shown in FIG. 7, in the hands-on mode, the surrounding state image with a wider range of the surrounding of the subject vehicle than in the hands-off mode may be displayed. On the other hand, in hands-off mode, the surrounding image with a narrower range of the surrounding of the subject vehicle than the hands-on mode may be displayed.

According to the above configuration, when the subject vehicle is in the hands-on mode, the state in a wider range than when the subject vehicle is in the hands-off mode is displayed. Therefore, it is possible to display the surrounding state image in a display mode according to whether the subject vehicle is in the hands-on mode or in the hands-off mode. In addition, depending on whether the subject vehicle is in the hands-on mode or the hands-off mode, the range around the subject vehicle shown in the surrounding state image is differentiated. Therefore, from this difference, the driver of the subject vehicle is enabled to more easily recognize whether to switch to the automated driving in the hands-on mode or the automated driving in the hands-off mode.

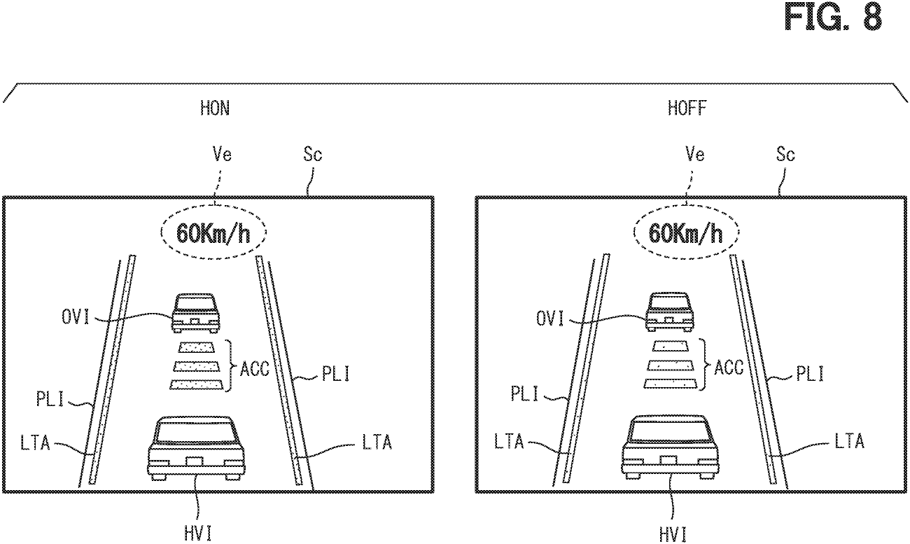

The display control unit 106 may differentiate a color tone of at least a part of the surrounding state image, depending on whether the mode identification unit 102 identifies the automated driving in the hands-on mode or the automated driving in the hands-off mode. As a specific example, as shown in FIG. 8, the color tone of the assistance implementation image (see ACC and LTA in FIG. 8) may be differentiated between the hands-on mode and the hands-off mode. The ACC of FIG. 8 shows the assistance implementation image representing that the ACC control is being implemented. The LTA of FIG. 8 shows the assistance implementation image representing that the LTA control is being implemented. Although FIG. 8 shows the example in which the color tone of the assistance implementation image is differentiated between the hands-on mode and the hands-off mode, the present disclosure is not necessarily limited to this. For example, a configuration may be adopted in which the color tone of an image element other than the assistance implementation image in the surrounding state image is differentiated.

According to the above configuration, the color tone of the image element in the surrounding state image is differentiated depending on whether the vehicle is in the hands-on mode or the hands-off mode. Therefore, from this difference, the driver of the subject vehicle is enabled to more easily recognize whether to switch to the automated driving in the hands-on mode or the automated driving in the hands-off mode.

In addition, when the mode identification unit 102 identifies the automated driving in the hands-on mode, the display control unit 106 preferably displays the image element of the surrounding state image in a color tone that attracts attention further than when the mode identification unit 102 identifies the automated driving in the hands-off mode. For example, when the hands-on mode is identified, the image element may be displayed in an exciting color tone such as red. On the other hand, when the hands-off mode is identified, the image element may be displayed in a calming color tone such as blue.

In the hands-on mode, it is considered that the driver needs to pay more attention to driving of the vehicle than in the hands-off mode. With respect to this, according to the above configuration, when the subject vehicle is in the hands-on mode, the image element of the surrounding state image is displayed in a color tone that is more likely to attract attention than when the subject vehicle is in the hands-off mode. Therefore, it is possible to display the surrounding state image in a display mode according to whether the subject vehicle is in the hands-on mode or in the hands-off mode.

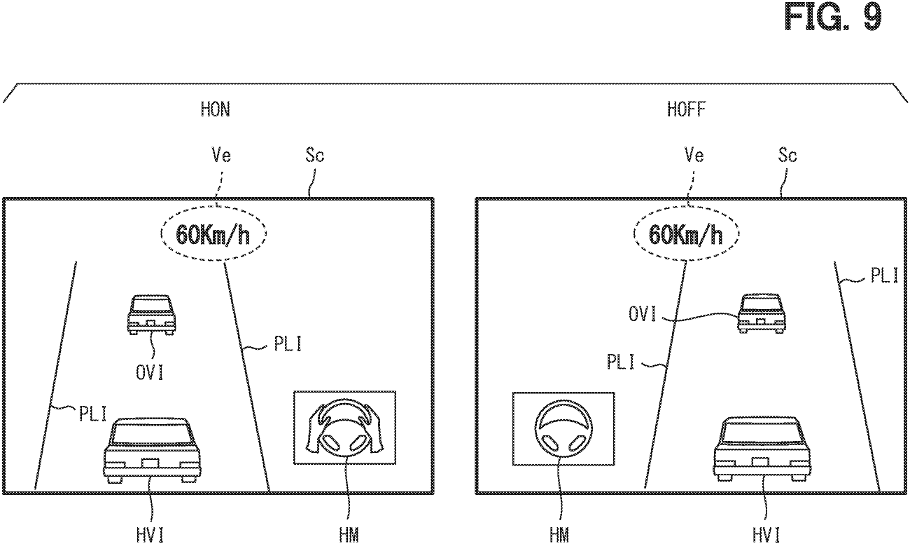

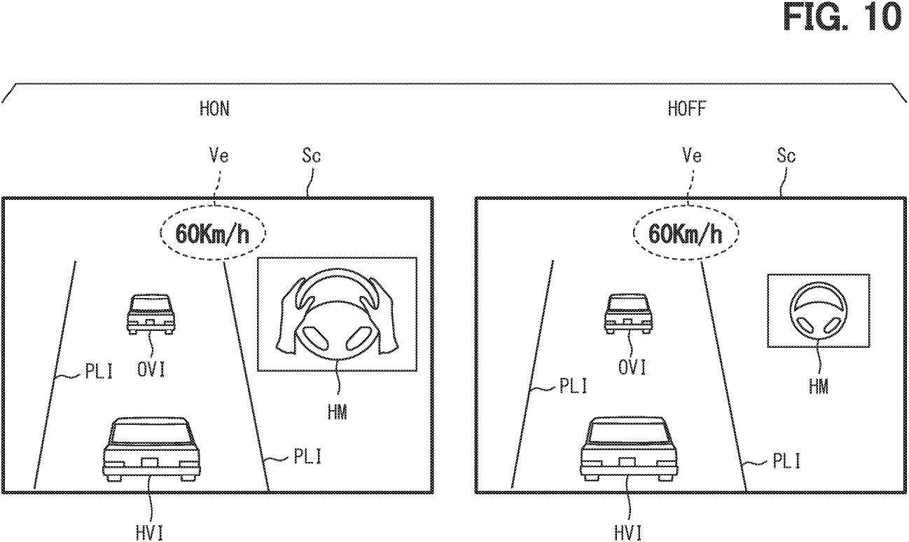

The display control unit 106 may differentiate at least one of an arrangement of an image element and a size ratio of an image element in the surrounding state image, depending on whether the mode identification unit 102 identifies the automated driving in the hands-on mode or the automated driving in the hands-off mode. As a specific example, as shown in FIG. 9, the arrangement of an image element may be differentiated between the hands-on mode and the hands-off mode. HM in FIG. 9 shows a hands-on-off image. In the example of FIG. 9, a horizontal arrangement of the image element showing the surrounding state of the subject vehicle in the surrounding state image and the hands-on-off image is differentiated between the hands-on mode and the hands-off mode.

According to the above configuration, the arrangement of the image element in the surrounding state image is differentiated depending on whether the subject vehicle is in the hands-on mode or the hands-off mode. Therefore, from this difference, the driver of the subject vehicle is enabled to more easily recognize whether to switch to the automated driving in the hands-on mode or the automated driving in the hands-off mode.

Further, as shown in FIG. 10, when the mode identification unit 102 identifies the automated driving in the hands-on mode, the display control unit 106 preferably increases the size ratio of the hands-on-off image more than when the mode identification unit 102 identifies the automated driving in the hands-off mode.

In the hands-off mode, the driver need not to grip the steering wheel. On the other hand, in the hands-on mode, the driver must make a motion to grip the steering wheel. Therefore, it is preferable, in the hands-on mode, that the driver is further facilitated to notice the hands-on-off image than in the hands-off mode. With respect to this, according to the above configuration, when the subject vehicle is in the hands-on mode, the hands-on-off image is displayed larger than when the subject vehicle is in hands-off mode. Therefore, the driver is facilitated to notice the hands-on-off image. Therefore, it is possible to display the surrounding state image in a display mode according to whether the subject vehicle is in the hands-on mode or in the hands-off mode.

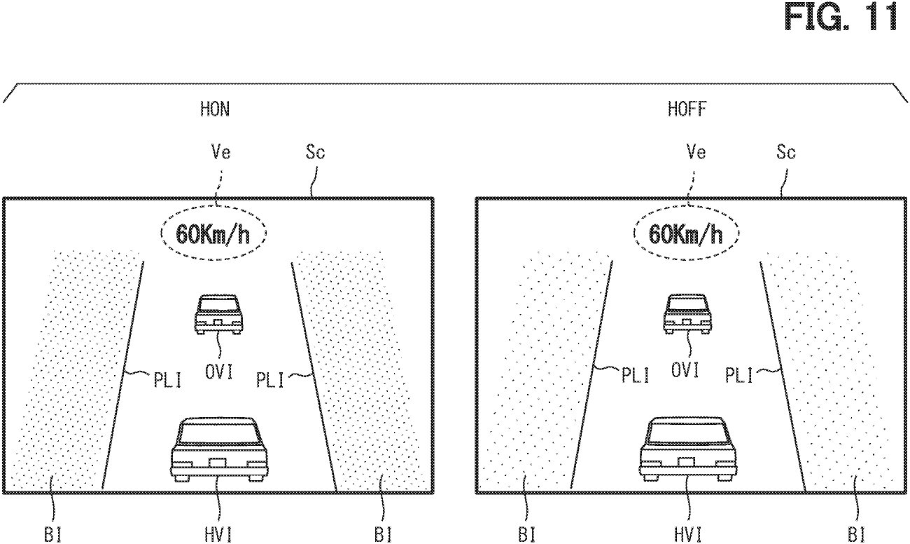

The display control unit 106 may differentiate a background image of the surrounding state image, depending on whether the mode identification unit 102 identifies the automated driving in the hands-on mode or the automated driving in the hands-off mode. As a specific example, as shown in FIG. 11, the background image may be differentiated between the hands-on mode and the hands-off mode. BI in FIG. 11 shows the background image. As an example, in a case where a certain pattern is displayed as the background image, the pattern may be differentiated. Alternatively, the background image may be displayed more clearly in the hands-on mode than in the hands-off mode.

According to the above configuration, the background image in the surrounding state image is differentiated depending on whether the subject vehicle is in the hands-on mode or the hands-off mode. Therefore, from this difference, the driver of the subject vehicle is enabled to more easily recognize whether to switch to the automated driving in the hands-on mode or the automated driving in the hands-off mode.

The display control unit 106 may be configured to implement a part of the operations of the switching of the various display mode as shown in FIGS. 4 to 11 depending on the hands-on mode or the hands-off mode. Alternatively, the display control unit 106 may be configured to combine multiple operations of the switching of the various display mode depending on the hands-on mode or the hands-off mode and implement the combination. When the subject vehicle switches from the automated driving at level 3 to the automated driving at level 1 or manual driving, the display control unit 106 may display the surrounding state image in a display mode of the hands-off.

In a case where the subject vehicle has switched to the automated driving in the hands-off mode and in at least one of cases where the subject vehicle changes the lane by the automated driving and where it is estimated that a nearby vehicle is to cut into the subject vehicle lane, the display control unit 106 preferably switches the display of the surrounding state image to the display that is of when the mode identification unit 102 identifies the automated driving in the hands-on mode, even when the automated driving in the hands-off mode continues. That is, even when the mode identification unit 102 identifies the automated driving in the hands-off mode for the subject vehicle, it is preferable to switch the display of the surrounding state image to the display mode similar to the display mode in the hands-on mode. The lane change identification unit 104 may identify that the subject vehicle changes the lane by automated driving. The interrupt estimation unit 103 may estimate interruption of a surrounding vehicle into the subject vehicle lane.

When the subject vehicle changes the lane by the automated driving and when it is estimated that a surrounding vehicle is to cut into the subject vehicle lane, even in the hands-off mode, it is considered that a possibility of occurrence of relatively large vehicle behavior increases, and a possibility of switching to the hands-on mode increases. With respect to this, according to the above configuration, even when the automated driving in the hands-off mode continues, when the possibility of switching to the hands-on mode increases, the driver is facilitated to prepare for the transition to the hands-on mode.

In a state where the subject vehicle is switched to the automated driving in the hands-off mode and when an elapsed time from this switching reaches a predetermined time, the display control unit 106 preferably switches to the display of the surrounding state image that is of when the mode identification unit 102 identifies the automated driving in the hands-on mode, even when the automated driving in the hands-off mode continues. The predetermined time referred to here is a time that may be arbitrarily set.

It is considered that an amount of information that the driver must confirm increases when the subject vehicle is in the hands-on mode rather than when the subject vehicle is in the hands-off mode. With respect to this, according to the above configuration, before switching from the hands-off mode to the hands-on mode, the display of the surrounding state image is switched to the display that is similar to the display in the hands-on mode. Therefore, when switching is made from the hands-off mode to the hands-on mode, it is possible to reduce an amount of newly added information and reduce a burden on the driver.

In a state where the subject vehicle is switched to the automated driving in the hands-off mode and when the grip identification unit 105 identifies gripping of the steering wheel, even when the automated driving in the hands-off mode continues, the display control unit 106 preferably switches to the display of the surrounding state image that is of when the mode identification unit 102 identifies the automated driving in the hands-on mode.

Even when the subject vehicle is in the hands-off mode, in a case where the driver grips the steering wheel, it is the same as a state in which the subject vehicle is in the hands-on mode. Therefore, it is considered that the surrounding state image similar to that in the hands-on mode is preferably displayed. With respect to this, according to the above configuration, even when the subject vehicle is in the hands-off mode, in a case where the driver grips the steering wheel, the surrounding state image similar to that in the hands-on mode can be displayed.

Further, the display control unit 106 may be configured to reverse or customize the display in the hands-on mode and the hands-off mode according to a driver’s preference. As an example, according to an input received by the user input device 93, the display in the hands-on mode and the hands-off mode may be reversed or customized.

### First Display Control Related Process Executed by HCU 10

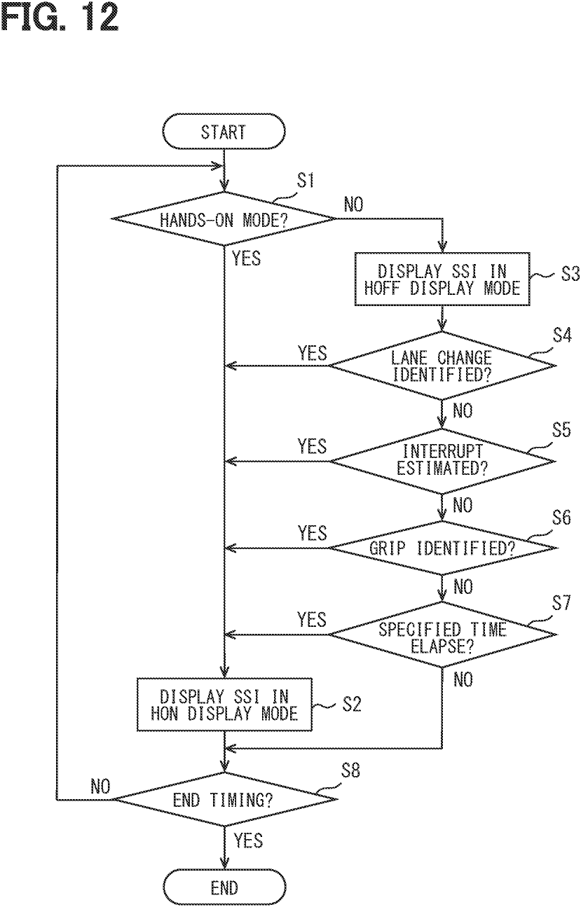

Herein, with reference to the flow chart of FIG. 12, an example of a flow of a process (hereinafter referred to as a first display control related process) related to the display control according to whether the HCU 10 is in the hands-on mode or the hands-off mode will be described. The flowchart of FIG. 12 may be started, for example, when takeover of driving is to be performed after the subject vehicle starts LV3 automated driving. The HCU 10 may determine that the takeover of the driving is to be performed in response to the takeover request acquisition unit 101 that has acquired the takeover request. Further, as described above, the display control unit 106 may not display the surrounding state image in the automated driving at LV3, and may display, for example, an image or the like explaining an action permitted as the second task on the display device 91.

First, in step S1, the mode identification unit 102 identifies whether the subject vehicle implements the automated driving in the hands-on mode or the automated driving in the hands-off mode after takeover of driving. When the hands-on mode is identified (YES in S1), the process proceeds to step S2. On the other hand, when the hands-off mode is identified (NO in S1), the process proceeds to step S3.

In step S2, the display control unit 106 causes the display device 91 to display the surrounding state image in the display mode of the hands-on mode described above. Then, the process proceeds to step S8. On the other hand, in step S3, the display control unit 106 causes the display device 91 to display the surrounding state image in the display mode of the hands-off mode described above. In the drawing, the hands-on mode is shown as HON. In the drawing, the hands-off mode is shown as HOFF. In the drawing, the surrounding state image is shown as SSI.

In step S4, when the lane change identification unit 104 identifies that the subject vehicle is to change the lane by the automated driving (YES in S4), the process proceeds to S2. On the other hand, when the lane change identification unit 104 does not specify that the subject vehicle is to change the lane by the automated driving (NO in S4), the process proceeds to step S5.

In step S5, when the interrupt estimation unit 103 estimates that the surrounding vehicle is to interrupt into the subject vehicle lane (YES in S5), the process proceeds to S2. On the other hand, when the interrupt estimation unit 103 does not estimate that a surrounding vehicle is to interrupt into the subject vehicle lane (NO in S5), the process proceeds to S6.

In step S6, when the grip identification unit 105 identifies gripping of the steering wheel (YES in S6), the process proceeds to S2. On the other hand, when the grip identification unit 105 has not identified gripping of the steering wheel (NO in S6), the process proceeds to S7.

In step S7, when an elapsed time from the takeover of driving has reached a predetermined time (YES in S7), the process proceeds to S2. On the other hand, when the elapsed time from the takeover of driving has not reached the predetermined time (NO in S7), the process proceeds to step S8.

In S8, when it is an end timing of the first display control related process (S8: YES), the first display control related process is ended. Alternatively, when it is not the end timing of the first display control related process (S8: NO), the process returns to S1 and repeats the process. An example of the end timing of the first display control related process is when a power switch is turned off, when the automated driving is switched to level 3 or higher, and the like.

### Summary of First Embodiment

According to the configuration of the first embodiment, display of the surrounding state image on the display device 91 used in the passenger compartment of the subject vehicle is differentiated depending on whether to switch, from the without-monitoring-duty automated driving, to the automated driving in the hands-on mode or the automated driving in the hands-off mode among the with-monitoring-duty automated driving. Therefore, the driver of the subject vehicle is facilitated to recognize, from the difference in the display of the surrounding state image, whether to switch to the automated driving in the hands-on mode or to switch to the automated driving in the hands-off mode. Consequently, when the state in which automated driving without the monitoring duty is switched to the with-monitoring-duty automated driving, it is possible for the driver to easily recognize whether the automated driving after the switching is in the hands-on mode or in the hands-off mode.

In addition, as previously described, it is conceivable that the required display mode is different between the automated driving in the hands-on mode and the automated driving in the hands-off mode. With respect to this, according to the configuration of the first embodiment, it is possible to display the surrounding state image in the display mode according to whether the subject vehicle is in the hands-on mode or in the hands-off mode. Further, in this respect, when the state in which the without-monitoring-duty automated driving is switched to the with-monitoring-duty automated driving, it is possible for the driver to easily recognize whether the automated driving after the switching is in the hands-on mode or in the hands-off mode.

### Second Embodiment

In the first embodiment, in the state where the subject vehicle is switched to the automated driving in the hands-off mode and when the grip identification unit 105 identifies gripping of the steering wheel, the display control unit 106 switches to the display of the surrounding state image that is of when the mode identification unit 102 identifies the automated driving in the hands-on mode. The configuration is not limited to this. For example, a configuration of the second embodiment described below may be employed. Hereinafter, one example of the second embodiment will be described with reference to the drawings. In the vehicle system 1 of the second embodiment, a part of the process in the display control unit 106 in the state where the subject vehicle is switched to the automated driving in the hands-off mode and when the grip identification unit 105 identifies gripping of the steering wheel, is different. Except for this, the configuration is similar to the configuration of the vehicle system 1 of the first embodiment.

The display control unit 106 of the second embodiment preferably continues display of the surrounding state image that is of when the mode identification unit 102 identifies the automated driving in the hands-off mode, in the state where the subject vehicle is switched to the automated driving in the hands-off mode and when the grip identification unit 105 identifies gripping of the steering wheel, for a predetermined time period after the grip identification unit 105 identifies grip of the steering wheel. Subsequently, the display control unit 106 preferably switches to the display of the surrounding state image that is of when the mode identification unit 102 identifies the automated driving in the hands-on mode, even when the automated driving in the hands-off mode continues. The predetermined time period referred to here is a time period that may be arbitrarily set.

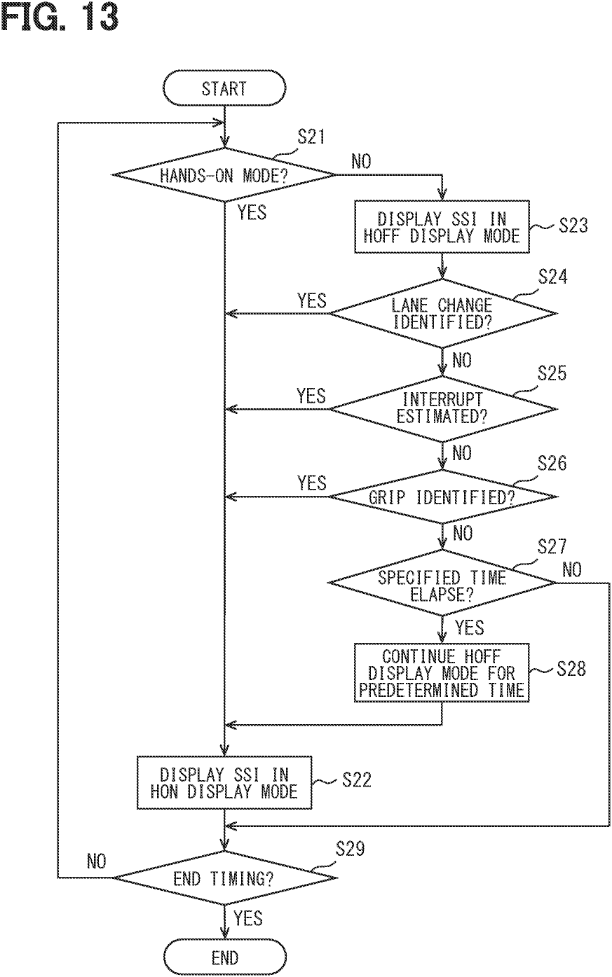

Herein, with reference to the flowchart of FIG. 13, an example of a flow of the first display control related process in the HCU 10 of the second embodiment will be described. The flowchart of FIG. 13 may be configured to be started under a condition that is similar to the condition of the flowchart of FIG. 12.

In step S21, the mode identification unit 102 identifies whether the subject vehicle implements the automated driving in the hands-on mode or the automated driving in the hands-off mode after takeover of driving. When the hands-on mode is identified (YES in S21), the process proceeds to step S22. On the other hand, when the hands-off mode is identified (NO in S21), the process proceeds to step S23.

In step S22, the display control unit 106 causes the display device 91 to display the surrounding state image in the display mode of the hands-on mode described above in the first embodiment. Then, the process proceeds to step S29. On the other hand, in step S23, the display control unit 106 causes the display device 91 to display the surrounding state image in the display mode of the hands-off mode described above in the first embodiment.

The process from step S24 to step S26 may be similar to the process from S1 to S6 described above. In step S27, when an elapsed time from the takeover of driving has reached a predetermined time (YES in S27), the process proceeds to S28. On the other hand, when the elapsed time from the takeover of driving has not reached the predetermined time (NO in S27), the process proceeds to step S29. In step S28, the display of the surrounding state image in the display mode of the hands-off mode is continued for a predetermined time period after grip of the steering wheel is identified. Subsequently, the process proceeds to S22.

In S29, when it is an end timing of the first display control related process (S29: YES), the first display control related process is ended. Alternatively, when it is not the end timing of the first display control related process (S29: NO), the process returns to S21 and repeats the process.

Similarly to the first embodiment, according to the configuration of the second embodiment, when the state in which the without-monitoring-duty automated driving is switched to the with-monitoring-duty automated driving, it is possible for the driver to easily recognize whether the automated driving after the switching is in the hands-on mode or in the hands-off mode. Further, according to the configuration of the second embodiment, when the subject vehicle is in the hands-off mode, the surrounding state image is displayed in the display mode of the hands-off mode for the predetermined time, even when the driver grips the steering wheel. Therefore, it is possible cause the driver to recognize that the driver does not need to grip the steering wheel.

### Third Embodiment

In the first embodiment, in the hands-off mode, only the lane marking image of the subject vehicle lane, among the subject vehicle lane and the surrounding lane, is displayed. When an obstacle is detected in a surrounding lane, the configuration of the third embodiment 3 below may be employed. Hereinafter, an example of the third embodiment will be described with reference to the drawings. In the following description, a surrounding vehicle is taken as an example of an obstacle.

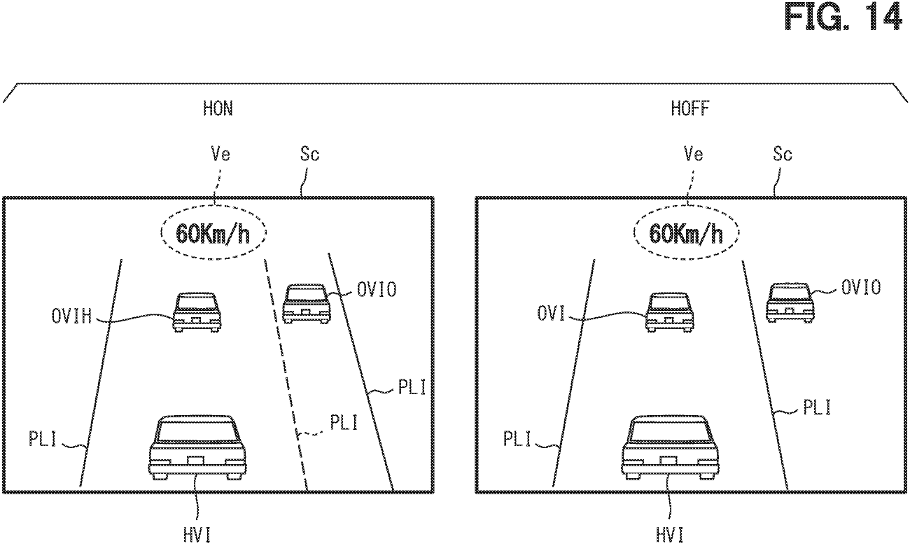

In the example of the third embodiment, as shown in FIG. 14, a display example in a case where the surrounding state image further includes a surrounding vehicle image will be described. OVIH in FIG. 14 shows an image representing a surrounding vehicle located in the subject vehicle lane. OVIO in FIG. 14 shows an image representing a surrounding vehicle located in a surrounding lane of the subject vehicle lane. In the third embodiment, as explained in the first embodiment, when the mode identification unit 102 identifies the automated driving in the hands-off mode, the display control unit 106 displays only the subject vehicle lane, among the subject vehicle lane and the surrounding lane. On the other hand, even when only the subject vehicle lane is displayed, the display control unit 106 enables to display, as the surrounding vehicle image, an image showing the surrounding vehicle corresponding to the subject vehicle lane and an image showing the surrounding vehicle corresponding to the surrounding lane.

According to the above configuration, compared to the display of the surrounding lane similarly to the example shown in FIG. 4 of the first embodiment, the necessary information is further selected by narrowing down the displayed item. Therefore, the driver is facilitated to understand. Even in a case where the display of the surrounding lane is omitted, the image showing the surrounding vehicle located in the surrounding lane is displayed. Therefore, this enables the driver to recognize the state of the surrounding lane. By omitting the display of the surrounding lane, it would also increase a possibility to suppress troublesomeness of the display. For example, an assumable configuration sequentially identifies a position of a lane from the map data and the recognition result of the lane marking by the surrounding monitoring sensor 60 and displays the lane. In this case, when the display of the lane is updated, the display may become blur. Due to this, as the number of lanes to be displayed increases, this blur becomes more noticeable to likely to cause a user to feel troublesomeness. Therefore, by omitting the display of the surrounding lane, it is possible to make this blur less noticeable and reduce the troublesomeness of the display.

### Fourth Embodiment

In the first embodiment, the example of takeover of driving from the automated driving at level 3 to the automated driving at level 2 has been explained. However, it is not necessarily limited to this. For example, the configuration may be applied when takeover of driving is implemented from the automated driving at level 4 or higher to the automated driving at level 2 or lower or manual driving.

### Fifth Embodiment

In the above embodiment, when the subject vehicle is in the automated driving at level 3 or higher, the surrounding image is not displayed. However, it is not necessarily limited to this. For example, a configuration (hereinafter referred to as fifth embodiment) may be employable that enables to display the surrounding state image when the subject vehicle is in the automated driving at level 3 or higher. Hereinafter, an example of the fifth embodiment will be described with reference to the drawings. The vehicle system 1 of the fifth embodiment is similar to the vehicle system 1 of the first embodiment, except for including an HCU 10a instead of the HCU 10.

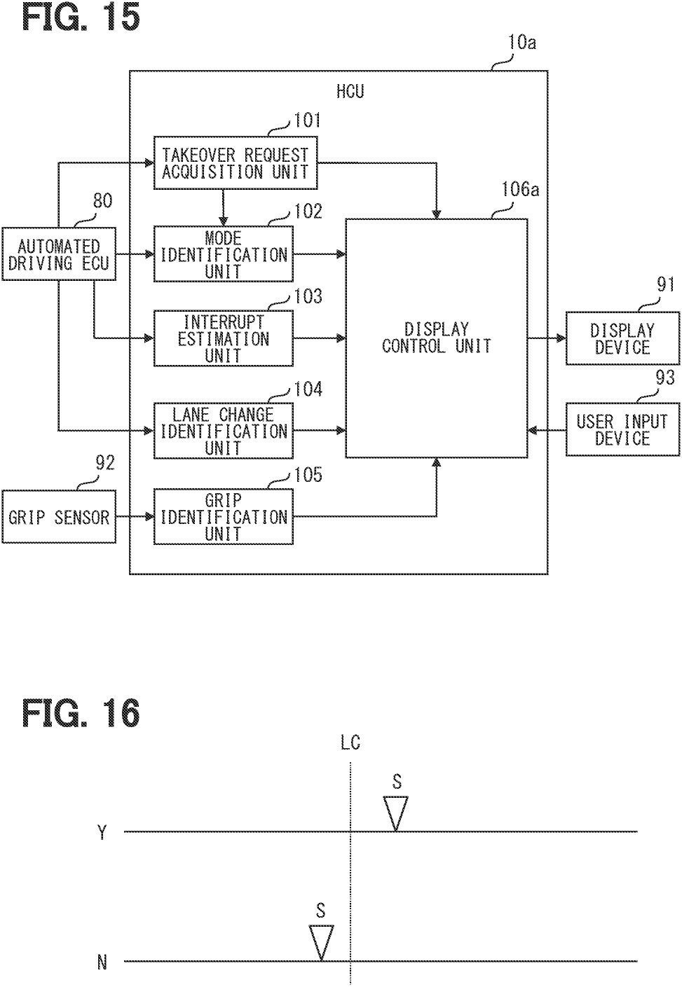

Herein, a schematic configuration of the HCU 10a will be described with reference to FIG. 15. As shown in FIG. 15, the HCU 10a includes, as functional blocks, the takeover request acquisition unit 101, a mode identification unit 102, an interrupt estimation unit 103, a lane change identification unit 104, the grip identification unit 105, and the display control unit 106 for the control of the indication on the display device 91. The HCU10a is similar to the HCU10 of the first embodiment except that the display control unit 106a is provided instead of the display control unit 106 of the first embodiment. The HCU 10a corresponds to the vehicle display control device. Execution of a process of each functional block of the HCU 10a by the computer corresponds to execution of a vehicle display control method.

The display control unit 106a is similar to the display control unit 106 of the first embodiment, except for that the display control unit 106a is capable of displaying the surrounding state image even when the subject vehicle is in the automated driving at level 3 or higher and that the display control unit 106a executes the process related to this. As follows, a process different from the process of the display control unit 106 of the first embodiment will be described.

For example, the display control unit 106a causes to display the surrounding state image even when the subject vehicle is in the automated driving at level 3 or higher. The automated driving at level 3 or higher may be rephrased as the without-monitoring-duty automated driving. The display control unit 106a changes, in a state where the surrounding state image is displayed while the subject vehicle is in the automated driving at level 3 or higher and when the level of automation (i.e. automation level) switches to a lower stage in automation, the display of the surrounding state image corresponding to the automation level before the switching to the display of the surrounding state image corresponding to the automation level after the switching, after a predetermined time period has elapsed from the switching of the automation level, regardless of whether the automated driving in the hands-on mode or the automated driving in the hands-off mode. The predetermined time period referred to here may be a time period that may be arbitrarily set. According to the above configuration, the display of the surrounding state image is changed after the switching of the automation level. Therefore, it is possible to restrict the driver from getting confused.

Similarly to the first embodiment, the display of the surrounding state image after the switching of the automation level may be changed depending on whether the automated driving in the hands-on mode or the automated driving in the hands-off mode. In addition, as an example, the display of the surrounding state image according to the automation level may be implemented as follows. At level 3, the lane marking image of only the subject vehicle lane, among the subject vehicle lane and a surrounding lane, may be displayed. At level 2, both the lane marking images of the subject vehicle lane and a surrounding lane may be displayed. As for the image of a surrounding vehicle, only the subject vehicle lane may be displayed at level 3, and the image of the surrounding vehicle may be displayed at level 2. In this case, application of the example shown in FIG. 4 may be excluded in the switching of the display of the surrounding state image in the hands-on mode or the hands-off mode at level 2.

Further, as described in the first embodiment, when the surrounding state image is not to be displayed while the subject vehicle is in the automated driving at level 3 or higher, the following procedure may be performed. The display control unit 106 may, in a state where the surrounding state image is displayed in the automated driving at level 3 or higher and when the automation level is switched to a lower stage in automation, change to the display of the surrounding state image corresponding to the automation level after the switching, at the same time as the switching of the automation level or before the switching of the automation level, regardless of whether the automated driving in the hands-on mode or the automated driving in the hands-off mode. The term “at the same time” as used herein may include an error that can be considered to be substantially at the same time. According to the above configuration, it is possible to quickly provide information about the surroundings of the subject vehicle to the driver.

Herein, a difference in timing of the switching of the display according to whether the surrounding state image is displayed or not when the subject vehicle is in the automated driving at level 3 or higher will be explained with reference to FIG. 16. Y in FIG. 16 shows an example in which the surrounding state image is displayed while the subject vehicle is in the automated driving at level 3 or higher. N in FIG. 16 shows an example in which the surrounding state image is not displayed while the subject vehicle is in the automated driving at level 3 or higher. LC in FIG. 16 shows the timing of switching of the automation level. S in FIG. 16 shows start timing of display of the surrounding state image according to the automation level after being switched. As shown in FIG. 16, when the surrounding state image is displayed while the subject vehicle is in the automated driving at level 3 or higher, after the switching of the automation level, the surrounding state image corresponding to the automation level after being switched is displayed. On the other hand, when the surrounding state image is not displayed while the subject vehicle is in the automated driving at level 3 or higher, the surrounding state image corresponding to the automation level after being switched is displayed at least before the time point of the switching of the automation level.

It should be noted that the configuration is not limited to that in which whether or not to display the surrounding state image in the automated driving of the subject vehicle at level 3 or higher is fixed. For example, a configuration may be employable such that a setting of whether or not to display the surrounding state image in the automated driving of the subject vehicle at level 3 or higher can be switched. The switching of the setting may be performed according to an input by a user received by the user input device 93. In this case, the display control unit 106a may be configured to selectively execute the above-described the process depending on whether or not to display the surrounding state image.

### Sixth Embodiment

As the configuration when the subject vehicle switches from the automated driving at level 4 or higher to the automated driving at LV3, a configuration of the sixth embodiment described below may also be employable. Hereinafter, an example of the sixth embodiment will be described with reference to the drawings.

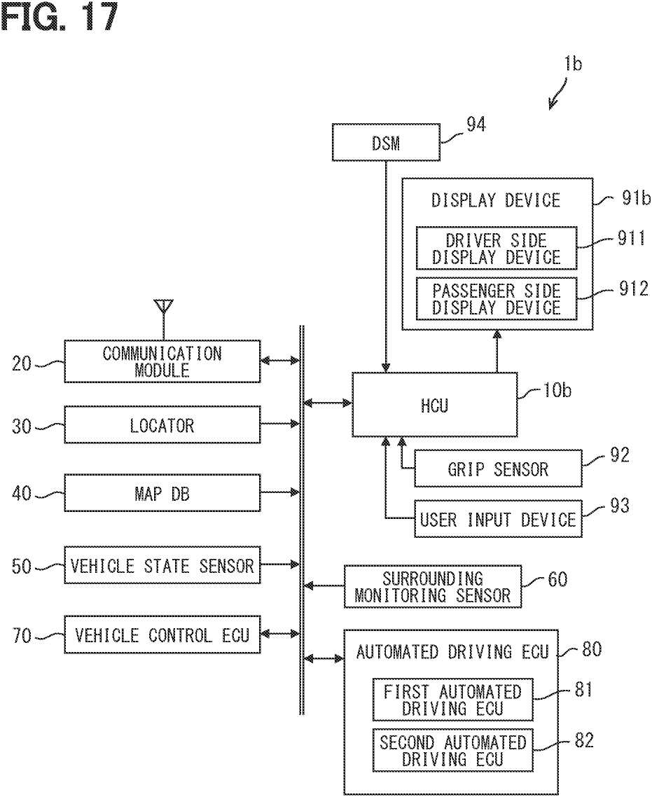

To begin with, with reference to FIG. 17, a vehicle system 1b of the sixth embodiment will be described. the vehicle system 1b includes As shown in FIG. 17, an HCU 10b, the communication module 20, the locator 30, the map DB 40, the vehicle state sensor 50, the surrounding monitoring sensor 60, the vehicle control ECU 70, the automated driving ECU 80, a display device 91b, the grip sensor 92, the user input device 93, and a DSM (Driver Status Monitor) 94. The vehicle system 1b is similar to the vehicle system 1 of the first embodiment, except for that the vehicle system 1b includes an HCU 10b and the display device 91b instead of the HCU 10 and the display device 91 and includes the DSM94. The vehicle system 1b corresponds to the vehicle display control system.

The display device 91b includes a driver side display device 911 and a passenger side display device 912, as shown in FIG. 17. The display device 91b is similar to the display device 91 of the first embodiment, except for that the display device 91b includes two types of the displays of the driver side display device 911 and the passenger side display device 912.

The driver side display device 911 is a display device whose display surface is positioned in front of the driver’s seat of the subject vehicle. As the driver side display device 911, a meter MID (Multi Information Display) or HUD (Head-Up Display) may be employable. The meter MID is a display device provided in front of the driver’s seat in the passenger compartment. As an example, the meter MID may be arranged on the meter panel. The HUD is provided, for example, on an instrument panel inside the vehicle. The HUD projects a display image formed by a projector onto a predetermined projection area on the front windshield as a projection member. A light of the display image reflected by the front windshield to an inside of a vehicle compartment is perceived by the driver seated in the driver’s seat. As a result, the driver can visually recognize the virtual image of the display image formed in front of the front windshield which is superimposed on a part of the foreground landscape. The HUD may be configured to project the display image onto a combiner provided in front of the driver’s seat instead of the front windshield. The display surface of the HUD is located above the display surface of the meter MID. A plurality of display devices may be used as the driver side display device 911.

The passenger side display device 912 is a display device other than the driver side display device 911. The display surface of the passenger side display device 912 is positioned at a location visible to a fellow passenger of the subject vehicle. The fellow passenger is an occupant of the subject vehicle other than the driver. The passenger side display device 912 may be a display device visible from a front passenger seat or a display device visible from a rear seat. A CID (Center Information Display) is an example of the display device that is visible from the front passenger seat. The CID is a display device placed in a center of an instrument panel of the subject vehicle. The display device visible from the rear seat may be a display device provided to a seat back of the front seat, a ceiling, or the like. A plurality of display devices may be used as the passenger side display device 912.

The DSM 94 is configured by a near infrared light source and a near infrared camera together with a control unit for controlling these elements and the like. The DSM 94 is provided to an upper surface of the instrument panel, for example, with the near infrared camera oriented toward the driver’s seat of the subject vehicle. The DSM 94 uses the near-infrared camera to capture a face of the driver to which near-infrared light is emitted from a near-infrared light source. The image captured by the near-infrared camera is subjected to image analysis by the control unit. The control unit detects a degree of awake of the driver based on a feature amount of the driver extracted by the image analysis of the captured image. The degree of awake is detected by distinguishing between at least an awaken state and a sleep state.

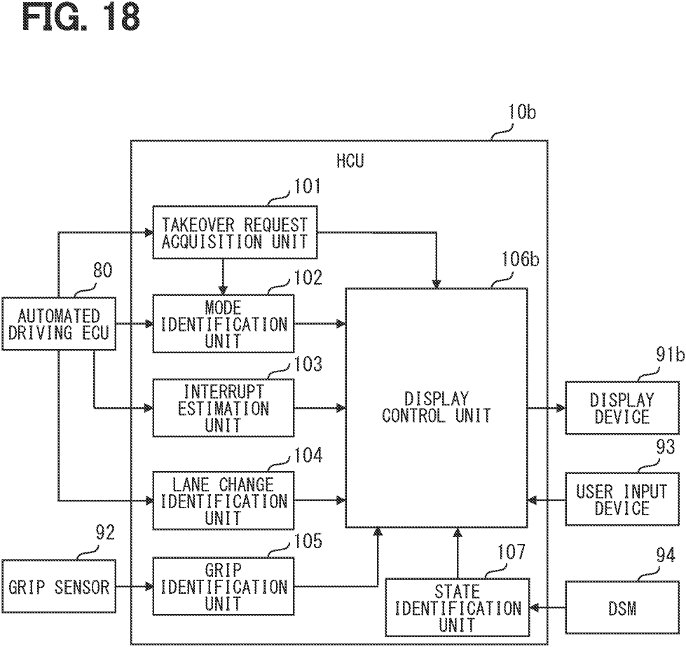

Herein, a schematic configuration of the HCU 10b will be described with reference to FIG. 18. As shown in FIG. 18, the HCU 10b includes, as functional blocks, the takeover request acquisition unit 101, a mode identification unit 102, an interrupt estimation unit 103, a lane change identification unit 104, the grip identification unit 105, a display control unit 106b, and a state identification unit 107 for the control of the indication on the display device 91b. The HCU 10b is similar to the HCU 10 of the first embodiment, except for that the HCU 10b includes the display control unit 106b instead of the display control unit 106 and that the HCU 10b includes the state identification unit 107. The HCU 10b corresponds to the vehicle display control device. Execution of a process of each functional block of the HCU 10b by the computer corresponds to execution of a vehicle display control method.

The state identification unit 107 identifies the state of the driver. The state identification unit 107 identifies a state related to awake of the driver from the degree of awake of the driver sequentially detected by the DSM 94. The state identification unit 107 distinguishes and identifies at least the wakeful state in which the driver is awake and the sleep state in which the driver is asleep. Herein, the configuration for detecting the awaken state of the driver with the control unit of the DSM 94 is shown. However, the state identification unit 107 may take a part of the function of this control unit. In addition, the state identification unit 107 may identify the awaken state of the drive from information other than the detection result of the DSM 94. For example, the awaken state of the driver may be specified from a detection result of a biosensor that detects a pulse wave of the driver.

The display control unit 106b is similar to the display control unit 106 and 106a except for difference in a part of processing. Processing different from that of the display control unit 106 and 106a will be described below. The display control unit 106b causes the display device 91b to display information related to driving of the subject vehicle (hereinafter referred to as driving related information). The driving related information displayed on the display device 91b includes a surrounding state image and an image that does not correspond to the surrounding state image. In other words, the driving related information also includes the surrounding state image. Images that do not correspond to the surrounding state images include an image explaining an action permitted as a second task (hereinafter referred to as ST explanation image), a vehicle speed image, a subject vehicle image, and an subject vehicle lane marking image (hereinafter referred to as subject vehicle lane image).

The display control unit 106b causes an amount of information of the driving related information, which is displayed on the display device 91b in the sleep-prohibited automated driving, to be larger than an amount of information of the driving related information, which is displayed on the display device 91b in the sleep-permitted automated driving, when the sleep-permitted automated driving is switched to the sleep-prohibited automated driving. In this case, a compared object may be an amount of information displayed on the same display device or an amount of information displayed by a plurality of display devices. The sleep-permitted automated driving is the automated driving at LV4 or higher, as described above. In the following, the automated driving at LV4 will be described as an example. The sleep-prohibited automated driving is the automated driving at LV3, as described above. The amount of information referred to here may be an amount of elements for each type of information. For example, examples of the elements for each type of information may include the subject vehicle image, the subject vehicle lane image, a marking image of a surrounding lane (hereinafter referred to as surrounding lane image), a surrounding vehicle image of the subject vehicle lane, a surrounding vehicle image in a surrounding lane, a vehicle speed, and the like.

For example, as an example to cause the amount of information displayed in the automated driving at LV3 to be larger than that in the automated driving at LV4, the following may be implemented. When the subject vehicle image and the subject vehicle lane image are displayed in the automated driving at LV4 but the surrounding vehicle image is not displayed, the surrounding vehicle image may be displayed in addition to the subject vehicle image and the subject vehicle lane image in the automated driving at LV3. In addition, when the subject vehicle image is displayed but the subject vehicle lane image is not displayed in the automated driving at LV4, the subject vehicle lane image may be displayed in addition to the subject vehicle image in the automated driving at LV3.

The display control unit 106b may cause the amount of the driving related information, which is displayed on the display device 91b after the automation is switched to the automated driving at a level of the with-monitoring-duty automated driving or lower, to be larger than the amount of information of the driving related information, which is displayed on the display device 91b in the sleep-permitted automated driving, when the automation is switched from the sleep-permitted automated driving to the with-monitoring-duty automated driving or lower level. Driving in the with-monitoring-duty automated driving or lower level includes the automated driving at levels 1 to 2 and the manual driving at level 0. In this case, the display control unit 106b preferably increases the amount of the driving related information displayed on the display device 91b more than that in the sleep-permitted automated driving, after the automation is switched to the with-monitoring-duty automated driving or lower level. According to this, it is possible to prevent the driver from neglecting to monitor the surroundings by paying too much attention to the display when the automation is switched to the automated driving at LV2 or lower level, which requires monitoring of the surroundings.

For example, as an example of increasing the amount of information displayed in driving at a level of the with-monitoring-duty automated driving or lower, the following may be performed. When the subject vehicle image is displayed but the subject vehicle lane image is not displayed in the automated driving at LV4, the subject vehicle lane image and the surrounding vehicle image may be displayed in addition to the subject vehicle image in the automated driving at automation level LV2 or lower.

In this case, in the automated driving at LV3, the subject vehicle lane image may be displayed in addition to the subject vehicle image.

The display control unit 106b preferably increases the amount of information of the driving related information, which is displayed on the display device 91b when the state identification unit 107 identifies that the driver is in the sleep state, to be larger than the amount of information of the driving related information, which is displayed on the display device 91b when the state identification unit 107 identifies that the driver is in the awaken state in the automated driving at LV4. According to this, even when the driver is asleep in the automated driving at LV4, it is possible for the fellow passenger to confirm more detailed information related to the driving of the subject vehicle. Therefore, even when the driver is asleep in the automated driving at LV4, it is possible to give the fellow passenger a sense of security. Herein, the case of displaying the driving related information on the display device 91b is taken as an example. However, the configuration can also be applied to a case where the display device 91 is caused to display the driving related information.

For example, as an example of increasing the amount of information displayed when the driver is in the sleep state to be more than that when the driver is in the awaken state in the automated driving at LV4, the following may be performed. When the driver is in the sleep state, the vehicle speed image is displayed, but the subject vehicle image and the subject vehicle lane image are not displayed. With respect to this, when the driver is in the sleep state, the subject vehicle image and the subject vehicle lane image may be displayed in addition to the vehicle speed image. In addition, when the driver is in the sleep state, the vehicle speed image, the subject vehicle image, and the subject vehicle lane image are displayed, but the surrounding vehicle image in the subject vehicle lane is not displayed. With respect to this, when the driver is in the sleep state, the surrounding vehicle image in the subject vehicle lane may be displayed in addition to the vehicle speed image, the subject vehicle image, and the subject vehicle lane image.

The display control unit 106b preferably increases the amount of the driving related information displayed on the passenger side display device 912 to be more than that on the driver side display device 911 when the state identification unit 107 identifies that the driver is in the sleep state in the automated driving at LV4, compared with the case where the state identification unit 107 identifies that the driver is in the awaken state. In this case, as an example, the driver side display device 911 may display the same amount of the driving related information when the state identification unit 107 identifies that the driver is in the sleep state and in the awaken state. On the other hand, when the state identification unit 107 identifies that the driver is in the awaken state in the automated driving at LV4, the driver side display device 911 and the passenger side display device 912 may display the same amount of the driving related information. According to this, when the driver is in the sleep state in the automated driving at LV4, it becomes possible to efficiently provide the fellow passenger with necessary information for the fellow passenger while reducing unnecessary indication.

For example, as an example of differentiating the amount of displayed information according to the state of the driver in the automated driving at LV4, the following may be performed. When the driver is in the awaken state, the vehicle speed image may be displayed, but the subject vehicle image and the subject vehicle lane image may not be displayed on both the driver side display device 911 and the passenger side display device 912. On the other hand, when the driver is in the sleep state, the vehicle speed image is displayed on the driver side display device 911, but the subject vehicle image and the subject vehicle lane image are not displayed on the driver side display device 911. In this case, in addition to the vehicle speed image, the subject vehicle image and the subject vehicle lane image may be displayed on the fellow passenger side display device 912.

When the state identification unit 107 identifies that the driver is not in the sleep state in the automated driving at LV4, and after the automated driving at LV4 is switched to the automated driving at LV3, the display control unit 106b preferably changes the display of information according to the stage of the automated driving at LV3 after the automation is switched. When the driver does not sleep in the automated driving at LV4, the driver is capable of grasping the surroundings of the subject vehicle. Therefore, the driver is capable of grasping the state around the subject vehicle, even without increasing the amount of the driving related information displayed on the display device 91b before the automation is switched to the automated driving at LV3. Therefore, there is no issue even when the amount of information of the driving related information displayed on the display device 91b is increased after switching to the automated driving at LV3.

On the other hand, when the state identification unit 107 identifies that the driver has transitioned from the sleep state to the awaken state in the automated driving at LV4, the display control unit 106b preferably changes the display of information according to the stage of the automated driving at LV3 after the automation is switched, before the automated driving at LV4 is switched to the automated driving at LV3. When the driver sleeps in the automated driving at LV4, the driver possibly does not of grasp the surroundings of the subject vehicle. Therefore, the amount of the driving related information displayed on the display device 91b is increased before switching to the automated driving at LV3, thereby to facilitate the driver to grasp the state around the subject vehicle. As a result, convenience for the driver is enhanced.

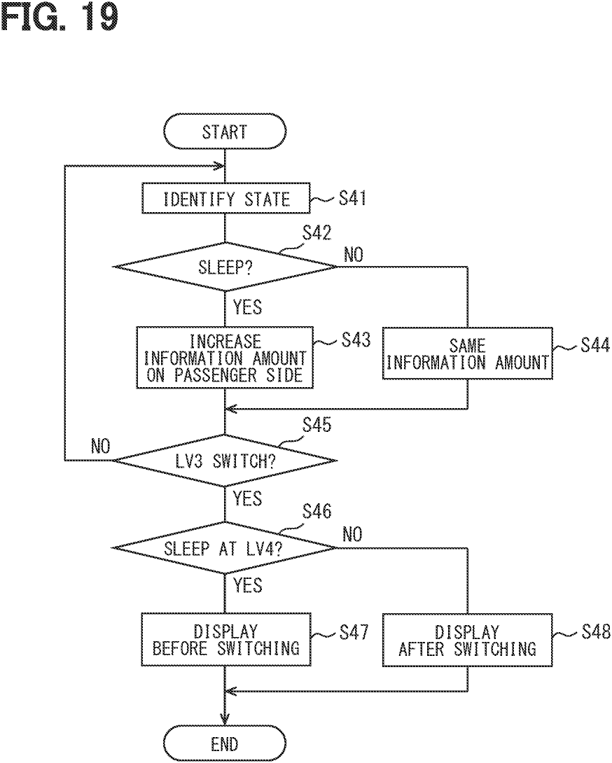

Herein, with reference to the flowchart of FIG. 19, an example of a flow of a process (hereinafter referred to as second display control related process) relating to a display control from the sleep-permitted automated driving to the sleep-prohibited automated driving in the HCU 10b will be described. The flowchart of FIG. 19 may be configured to be started, for example, when the subject vehicle starts the automated driving at LV4 or higher.

First, in step S41, the state identification unit 107 identifies the state of the driver. In step S42, when the driver is identified to be in the sleep state in S41 (YES in S42), the process proceeds to step S43. On the other hand, in S41, when the driver is identified to be in the awake state (NO in S42), the process proceeds to step S44.

In step S43, the display control unit 106b increases the amount of the driving related information displayed on the passenger side display device 912 to be more than that on the driver side display device 911. Then, the process proceeds to step S45. On the other hand, in step S44, the display control unit 106b causes the driver side display device 911 and the fellow passenger side display device 912 to display the same amount of the driving related information. Then, the process proceeds to step S45.

In step S45, when switching to the automated driving at LV3 is performed (YES in S45), the process proceeds to step S46. On the other hand, when switching to the automated driving at LV3 is not performed (NO in S45), the process returns to S41, the process is repeated. The switching to the automated driving at LV3 represents a state in which switching is about to be performed but switching has not yet started. The automated driving at LV3 is the sleep-prohibited automated driving. Therefore, it is assumed that the driver is in the awaken state when switching to the automated driving at LV3 is performed.

In step S46, when the driver has been identified to be in the sleep state in S41 (YES in S46), the process proceeds to step S47. On the other hand, when the driver has not been identified to be in the sleep state in S41 (NO in S46), the process proceeds to step S48.

In step S47, before switching to the automated driving at LV3, the display control unit 106b changes the display of information according to the stage of the automated driving at LV3 after switching, and ends the second display control related process. On the other hand, in step S48, after switching to the automated driving at LV3, the display control unit 106b changes the display of information according to the stage of the automated driving at LV3 after switching, and ends the second display control related process.

### Seventh Embodiment

It is not limited to the configuration of the sixth embodiment, and a configuration of the seventh embodiment described below may be employed. Hereinafter, an example of the seventh embodiment will be described with reference to the drawings. The vehicle system 1b of the seventh embodiment is similar to the vehicle system 1b of the first embodiment, except for including an HCU 10c instead of the HCU 10b.

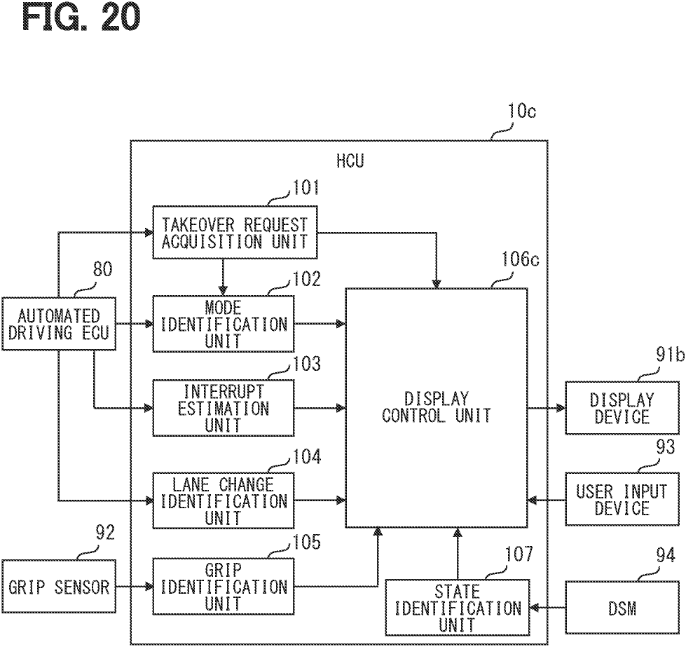

Herein, a schematic configuration of the HCU 10c will be described with reference to FIG. 20. As shown in FIG. 20, the HCU 10c includes, as functional blocks, the takeover request acquisition unit 101, a mode identification unit 102, an interrupt estimation unit 103, a lane change identification unit 104, the grip identification unit 105, a display control unit 106c, and the state identification unit 107 for the control of the indication on the display device 91b. The HCU10c is similar to the HCU10b of the sixth embodiment except that the display control unit 106c is provided instead of the display control unit 106b. The HCU 10c corresponds to the vehicle display control device. Execution of a process of each functional block of the HCU 10c by the computer corresponds to execution of a vehicle display control method.

The display control unit 106c is similar to the display control unit 106b except for difference in a part of processing. Processing different from that of the display control units 106b will be described below. When the sleep-permitted automated driving is switched to the sleep-prohibited automated driving and when the state identification unit 107 has identified that the driver is in the awaken state before a predetermined time period in advance of a scheduled switching timing, the display control unit 106c changes the display of information according to the stage of the automated driving after switching, after switching from the sleep-permitted automated driving to the sleep-prohibited automated driving. On the other hand, when the state identification unit 107 has identified that the driver has transitioned from the sleep state to the awaken state within a predetermined time period before the scheduled switching timing, the display control unit 106c changes the display of information according to the stage of the automated driving after switching, before switching from the sleep-permitted automated driving to the sleep-prohibited automated driving. The sleep-permitted automated driving is the automated driving at LV4 or higher, as described above. In the following, the automated driving at LV4 will be described as an example. The sleep-prohibited automated driving is the automated driving at LV3, as described above. The predetermined time period herein may be longer than a time period, which is estimated to be required until the driver can grasp the surrounding state of the subject vehicle after the driver transitions from the sleep state to the awaken state. The predetermined time period referred to here may be a time period that may be arbitrarily set.

In the seventh embodiment, the process of S46 in the flowchart of FIG. 19 may be modified as follows. In the seventh embodiment, in the process of S46, when the state identification unit 107 continually identifies the awaken state, before the predetermined time period in advance of the scheduled timing of the switching to the automated driving at LV3, the process may proceed to step S47. On the other hand, when the state identification unit 107 has identified the sleep state within the predetermined time period in advance of the scheduled timing of the switching to the automated driving at LV3, the process may proceed to step S48.

### Eighth Embodiment

In the sixth embodiment and the seventh embodiment, the configuration in which the HCU 10b and 10c is provided with the state identification unit 107 is shown. However, it is not necessarily limited to this. For example, a configuration may be employable in which the HCU 10b and 10c is not provided with the state identification unit 107, and does not perform the display control according to whether the driver is in the awaken state or in the sleeping state.

It should be noted that the present disclosure is not limited to the embodiments described above, and various modifications are possible within the scope indicated in the claims, and embodiments obtained by appropriately combining technical means disclosed in different embodiments are also included in the technical scope of the present disclosure. The controller and the method thereof described in the present disclosure may be implemented by a special purpose computer which includes a processor programmed to execute one or more functions executed by a computer program. Alternatively, the device and the method thereof described in the present disclosure may be implemented by a special purpose hardware logic circuit. Alternatively, the device and the method thereof described in the present disclosure may be implemented by one or more special purpose computers configured by a combination of a processor executing a computer program and one or more hardware logic circuits. The computer programs may be stored, as instructions to be executed by a computer, in a tangible non-transitory computer-readable medium.

What is claimed is:

1. A vehicle display control device for a vehicle, the vehicle configured to switch from a without-monitoring-duty automated driving without a duty of monitoring by a driver to a with-monitoring-duty automated driving with the duty of monitoring by the driver, the vehicle display control device comprising:
a display control unit configured to cause a display device, which is to be used in an interior of the vehicle, to display a surrounding state image that is an image to show a surrounding state of the vehicle;
a mode identification unit configured to identify whether an automated driving in a hands-on mode, which requires gripping of a steering wheel of the vehicle, or an automated driving in a hands-off mode, which does not require gripping of the steering wheel, is performed when the vehicle is in the with-monitoring-duty automated driving; and
the display control unit is configured to, when the vehicle switches from the without-monitoring-duty automated driving to the with-monitoring-duty automated driving, differentiate a display of the surrounding state image, depending on whether the mode identification unit identifies the automated driving in the hands-on mode or the automated driving in the hands-off mode.

2. The vehicle display control device according to claim 1, wherein
the surrounding state image includes an image of a lane, and
the display control unit is configured to
display a subject vehicle lane, which is a driving lane of the vehicle, and a surrounding lane, which is other than the subject vehicle lane, when the mode identification unit identifies the automated driving in the hands-on mode, and
display only the subject vehicle lane among the subject vehicle lane and the surrounding lane, when the mode identification unit identifies the automated driving in the hands-off mode.

3. The vehicle display control device according to claim 2, wherein
the surrounding state image includes an image showing an obstacle, and
the display control unit is configured to, when the mode identification unit identifies the automated driving in the hands-off mode,
display only the subject vehicle lane among the subject vehicle lane and the surrounding lane and
display both the image showing the obstacle corresponding to the subject vehicle lane and the image showing the obstacle corresponding to the surrounding lane.

4. The vehicle display control device according to claim 1, wherein
the surrounding state image is an image of a surrounding of the vehicle viewed from a virtual viewpoint, and
the display control unit is configured to
when the mode identification unit identifies the automated driving in the hands-on mode, display the surrounding state image viewed from the virtual viewpoint, which is farther from a display target than the virtual viewpoint when the mode identification unit identifies the automated driving in the hands-off mode, and
when the mode identification unit identifies the automated driving in the hands-off mode, display the surrounding state image viewed from the virtual viewpoint, which is closer to the display target than the virtual viewpoint when the mode identification unit identifies the automated driving in the hands-on mode.

5. The vehicle display control device according to claim 1, wherein
the surrounding state image is an image of a surrounding of the vehicle viewed from a virtual viewpoint, and
the display control unit is configured to
when the mode identification unit identifies the automated driving in the hands-on mode, display the surrounding state image viewed from the virtual viewpoint that looks down from an upper position than the virtual viewpoint when the mode identification unit identifies the automated driving in the hands-off mode and
when the mode identification unit identifies the automated driving in the hands-off mode, display the surrounding state image viewed from the virtual viewpoint that looks down from a lower position than the virtual viewpoint when the mode identification unit identifies the automated driving in the hands-on mode.

6. The vehicle display control device according to claim 1, wherein
the display control unit is configured to
when the mode identification unit identifies the automated driving in the hands-on mode, cause a region around the vehicle, which is displayed as the surrounding state image, to be wider than the region when the mode identification unit identifies the automated driving in the hands-off mode, and
when the mode identification unit identifies the automated driving in the hands-off mode, cause the region around the vehicle, which is displayed as the surrounding state image, to be narrower than the region when the mode identification unit identifies the automated driving in the hands-on mode.

7. The vehicle display control device according to claim 1, wherein
the display control unit is configured to differentiate a color tone of at least a part of the surrounding state image depending on whether the mode identification unit identifies the automated driving in the hands-on mode or the automated driving in the hands-off mode.

8. The vehicle display control device according to claim 1, wherein
the surrounding state image includes a plurality of image elements, and
the display control unit is configured to differentiate at least one of an arrangement of the image elements or a size ratio of the image elements depending on whether the mode identification unit identifies the automated driving in the hands-on mode or the automated driving in the hands-off mode.

9. The vehicle display control device according to claim 8, wherein
the surrounding state image includes, as one of the image elements, a hands-on-off image that is an image indicating whether the hands-on mode or the hands-off mode, and
the display control unit is configured to, when the mode identification unit identifies the automated driving in the hands-on mode, increase the size ratio of the hands-on-off image more than the size ratio when the mode identification unit identifies the automated driving in the hands-off mode.

10. The vehicle display control device according to claim 1, wherein
the surrounding state image includes a background image, and
the display control unit is configured to differentiate the background image depending on whether the mode identification unit identifies the automated driving in the hands-on mode or the automated driving in the hands-off mode.

11. The vehicle display control device according to claim 1, wherein
the display control unit is configured to, when the vehicle has switched to the automated driving in the hands-off mode and in at least one of cases where the vehicle changes a lane by the automated driving or where a vehicle around the vehicle is estimated to cut into a driving lane of the vehicle, switch a display of the surrounding state image to a display that is of when the mode identification unit identifies the automated driving in the hands-on mode, even when the automated driving in the hands-off mode continues.

12. The vehicle display control device according to claim 1, wherein
the display control unit is configured to, when switching of the vehicle to the automated driving in the hands-off mode is made and when an elapsed time from the switching reaches a predetermined time, switch a display of the surrounding state image to a display of the surrounding state image that is of when the mode identification unit identifies the automated driving in the hands-on mode, even when the automated driving in the hands-off mode continues.

13. The vehicle display control device according to claim 1, further comprising:
a grip identification unit configured to identify gripping of a steering wheel by the driver, wherein
the display control unit is configured to, when switching of the vehicle to the automated driving in the hands-off mode is made and when the grip identification unit identifies gripping of the steering wheel, switch a display of the surrounding state image to a display of the surrounding state image that is of when the mode identification unit identifies the automated driving in the hands-on mode, even when the automated driving in the hands-off mode continues.

14. The vehicle display control device according to claim 1, further comprising:
a grip identification unit configured to identify gripping of a steering wheel by the driver, wherein
the display control unit is configured to
when the vehicle is switched to the automated driving in the hands-off mode and when the grip identification unit identifies gripping of the steering wheel by the driver, continue a display of the surrounding state image that is of when the mode identification unit identifies the automated driving in the hands-off mode for a predetermined time after the grip identification unit identifies gripping of the steering wheel by the driver, and
subsequently switch the display of the surrounding state image to a display of the surrounding state image that is of when the mode identification unit identifies the automated driving in the hands-on mode, even when the automated driving in the hands-off mode continues.

15. The vehicle display control device according to claim 1, wherein
the display control unit is configured to, in a state where the display control unit displays the surrounding state image in the without-monitoring-duty automated driving and when switching of a stage of automated driving to a lower stage in automation is made, change a display of the surrounding state image corresponding to the stage of automated driving before the switching to a display of the surrounding state image corresponding to the stage of automated driving after the switching, after a predetermined time has elapsed from the switching, regardless of whether the automated driving in the hands-on mode or the automated driving in the hands-off mode.

16. The vehicle display control device according to claim 1, wherein
the display control unit is configured to, in a state where the display control unit does not display the surrounding state image in the without-monitoring-duty automated driving and when switching of a stage of automated driving to a lower stage in automation is made, change a display of the surrounding state image according to the stage of automated driving after the switching, at the same time as the switching or before the switching, regardless of whether the automated driving in the hands-on mode or the automated driving in the hands-off mode.

17. The vehicle display control device according to claim 1, wherein
the vehicle is configured to switch, as a stage of automated driving, at least between the without-monitoring-duty automated driving and the with-monitoring-duty automated driving,
the vehicle is configured to perform, as the without-monitoring-duty automated driving, at least a sleep-permitted automated driving, in which the driver is permitted to sleep, and a sleep-prohibited automated driving, in which the driver is not permitted to sleep,
the display control unit is configured to cause the display device to display driving related information, which is related to driving of the vehicle, and
the display control unit is configured to, when the sleep-permitted automated driving is switched to the sleep-prohibited automated driving, cause an amount of the driving related information, which is displayed on the display device in the sleep-prohibited automated driving, to be larger than an amount of the driving related information, which is displayed on the display device in the sleep-permitted automated driving.

18. The vehicle display control device according to claim 17, further comprising:
a state identification unit configured to identify a state of the driver, wherein
the display control unit is configured to
when the state identification unit identifies that the driver is not in a sleep state in the sleep-permitted automated driving, change a display of information, after switching of the sleep-permitted automated driving to the sleep-prohibited automated driving is made, according to the stage of automated driving after the switching, and
when the state identification unit identifies that the driver transitions from the sleep state to an awaken state in the sleep-permitted automated driving, change the display of information, before switching from the sleep-permitted automated driving to the sleep-prohibited automated driving is made, according to the stage of automated driving after the switching.

19. The vehicle display control device according to claim 17, further comprising:
a state identification unit configured to identify a state of the driver, wherein
the display control unit is configured to
when switching from the sleep-permitted automated driving to the sleep-prohibited automated driving is made and when the state identification unit has identified that the driver is in an awaken state before a predetermined time period in advance of a scheduled timing of the switching, change a display of information, after switching from the sleep-permitted automated driving to the sleep-prohibited automated driving, according to the stage of automated driving after the switching, and
when the state identification unit has identified that the driver has transitioned from a sleep state to the awaken state within a predetermined time period before the scheduled timing of the switching, change the display of information, before switching from the sleep-permitted automated driving to the sleep-prohibited automated driving, according to the stage of automated driving after the switching.

20. The vehicle display control device according to claim 1, wherein
the vehicle is configured to switch, as a stage of automated driving, at least between the without-monitoring-duty automated driving and the with-monitoring-duty automated driving,
the vehicle is configured to perform, as the without-monitoring-duty automated driving, at least a sleep-permitted automated driving, in which the driver is permitted to sleep, and a sleep-prohibited automated driving, in which the driver is not permitted to sleep,
the display control unit is configured to cause the display device to display driving related information, which is related to driving of the vehicle,
the vehicle display control device further comprising:
a state identification unit configured to identify a state of the driver, wherein
the display control unit is configured to cause an amount of the driving related information, which is displayed on the display device when the state identification unit identifies that the driver is in a sleep state, to be larger than an amount of the driving related information, which is displayed on the display device when the state identification unit identifies that the driver is in a awaken state in the sleep permitted automated driving.

21. The vehicle display control device according to claim 20, wherein
the display control unit is configured to
cause the display device to display information, and
control, as the display device, a display of a driver side display device, which has a display surface positioned in front of a driver’s seat of the vehicle, and a display of a passenger side display device, which is other than the driver side display and having a display surface positioned at a location visible to a passenger of the vehicle, and
the display control unit is configured to, when the state identification unit identifies the driver in the sleep state in the sleep-permitted automated driving, increase an amount of the driving related information displayed on the passenger side display to be larger than an amount of the driving related information displayed on the driver side display, compared with a state where the state identification unit identifies the driver in the awaken state.

22. The vehicle display control device according to claim 1, wherein
the vehicle is configured to switch at least between the without-monitoring-duty automated driving and the with-monitoring-duty automated driving,
the vehicle is configured to perform, as the without-monitoring-duty automated driving, at least a sleep-permitted automated driving, in which the driver is permitted to sleep, and a sleep-prohibited automated driving, in which the driver is not permitted to sleep,
the display control unit is configured to cause the display device to display driving related information, which is related to driving of the vehicle, and
the display control unit is configured to, when switching from the sleep-permitted automated driving to a driving at a stage of the with-monitoring-duty automated driving or lower in automation is made, increase, after the switching, an amount of the driving related information displayed on the display device to be larger than an amount of the driving related information displayed in the sleep-permitted automated driving.

23. A vehicle display control system for a vehicle, the vehicle configured to switch from a without-monitoring-duty automated driving without a duty of monitoring by a driver to a with-monitoring-duty automated driving with the duty of monitoring by the driver, the vehicle display control system comprising:
a display device to be provided to the vehicle so that a display surfaces of the display device is oriented to an interior of the vehicle; and
the vehicle display control device according to claim 1.

24. A vehicle display control method for a vehicle, the vehicle configured to switch from a without-monitoring-duty automated driving without a duty of monitoring by a driver to a with-monitoring-duty automated driving with the duty of monitoring by the driver, the vehicle display control method executable by at least one processor and comprising:
causing, in a display control process, a display device, which is to be used in an interior of the vehicle, to display a surrounding state image that is an image to show a surrounding state of the vehicle;
identifying, in a mode identification process, whether an automated driving in a hands-on mode, which requires gripping of a steering wheel of the vehicle, or an automated driving in a hands-off mode, which does not require gripping of the steering wheel, is performed when the vehicle is in the with-monitoring-duty automated driving; and
differentiating a display of the surrounding state image, when the vehicle switches from the without-monitoring-duty automated driving to the with-monitoring-duty automated driving, depending on whether the mode identification process identifies the automated driving in the hands-on mode or the automated driving in the hands-off mode.

25. A vehicle display control device comprising:
a processor configured to
cause a display device, which is to be used in an interior of a vehicle, to display a surrounding state image that is an image to show a surrounding state of the vehicle;
identify whether an automated driving in a hands-on mode, which requires gripping of a steering wheel of the vehicle, or an automated driving in a hands-off mode, which does not require gripping of the steering wheel, is performed when the vehicle is in a with-monitoring-duty automated driving with a duty of monitoring by a driver; and
differentiate a display of the surrounding state image, when the vehicle switches from a without-monitoring-duty automated driving without the duty of monitoring by the driver to the with-monitoring-duty automated driving, depending on identification of whether the automated driving in the hands-on mode or the automated driving in the hands-off mode.
